(19) United States
(12) Patent Application Publication
(10) Pub. No.: US 2008/0306986 A1
(43) Pub. Date: Dec. 11, 2008

(54) Migration of Legacy Applications

(75) Inventor: John David Doyle, SR., Charlotte, NC (US)

Correspondence Address: Kenneth F. Smolik;Banner & Witcoff, Ltd., Ten South Wacker Drive, Chicago, IL, 60606-7407, US

(73) Assignee: Accenture Global Services GmbH, Schaffhausen (CH)

(21) Appl. No.: 12/051,401

(22) Filed: Mar. 19, 2008

Related U.S. Application Data
(60) Provisional application No. 60/942,789, filed on Jun. 8, 2007.

(51) Int. Cl. G06F 9/44; G06F 7/00; G06F 17/30

(52) U.S. Cl. 707/102; 717/136; 707/E17.005

(57) ABSTRACT

Embodiments of the invention provide apparatuses, computer media, and methods for obtaining a rule component from a legacy application and subsequently generating an intermediate state expression from a legacy rule of the rule component. The intermediate state expression is converted to a target rule, which is utilized by the target application. Also, a data component is obtained from the legacy application, and an intermediate data element is generated from a legacy data element. The intermediate data element is converted to a target data element that may be accessed by the target application when executing the target rule. A vocabulary item is extracted from the rule component. The vocabulary item is aggregated with the intermediate state expression to form the target rule. The target rule is subsequently deployed to the target application.

This application claims priority to provisional U.S. Application Ser. No. 60/942,789 (“Migration of Legacy Applications”), filed Jun. 8, 2007.

### FIELD OF THE INVENTION

This invention relates generally to migrating business rules and data from a legacy application to a designated application.

### BACKGROUND OF THE INVENTION

Businesses and government agencies often invest in an application and depend on the application for its successful operation over the years. The application (often called a legacy application) must be maintained; however, at some point of time maintaining the legacy application becomes difficult. Consequently, a business or government agency may wish to migrate from the legacy application to a target application, which may incorporate new hardware and software. It is typically important to facilitate the migration to reduce the disruption to operations.

As an example of the above situation, a number of government agencies utilize the Accenture™ Tax Administrative System (TAS) for collecting tax revenue from individuals and businesses in the tax jurisdiction. While the Tax Administrative System (corresponding to a legacy application) performs in accordance with the original design requirements, the government agency may find that the system is becoming too difficult to maintain since the legacy application is written in a more rudimentary software language called COBOL. Moreover, a new (target) application (e.g., SAP® Public Sector Collection and Disbursement (PSCD) software and/or Microsoft BizTalk™ business rules engine) may provide enhancements with respect to the legacy application. Any disruption to tax collection, needless to say, can be very costly to the functioning of the government operation.

The above prior art examples illustrate the strong market need to facilitate the migration from a legacy application to a target application.

### BRIEF SUMMARY OF THE INVENTION

Aspects of the invention provide apparatuses, computer media, and methods for obtaining a first component from a legacy application and subsequently generating an intermediate state element from a legacy element of the first component. The intermediate state element is converted to a target element, which is utilized by the target application.

With an aspect of the invention, a rule component is obtained from the legacy application, which contains legacy source code specified in a first software language. An intermediate state expression is generated from a legacy rule, which is contained in the rule component. The intermediate state expression is converted to a target rule, which is executed by a target application that is configured to execute the target rule. The target application may contain target source code specified in a second software language. Also, a data component is obtained from the legacy application, and an intermediate data element is generated from a legacy data element. The intermediate data element is converted to a target data element that may be accessed by the target application when executing the target rule.

With another aspect of the invention, a vocabulary item is extracted from the rule component. The vocabulary item is aggregated with the intermediate state expression to form the target rule. The target rule is subsequently deployed to the target application.

With another aspect, another component, e.g., a correspondence, interface, or reports component, is obtained from the legacy application, and a corresponding intermediate element is generated. The corresponding intermediate element is converted to the target application.

With an aspect of the invention, the legacy application is directed to a tax administration system that uses COBOL source software.

### BRIEF DESCRIPTION OF THE DRAWINGS

The present invention is illustrated by way of example and not limited in the accompanying figures in which like reference numerals indicate similar elements and in which:

FIG. 1 shows an architecture in which a legacy application is migrated to a designated application in accordance with embodiment of the invention.

FIG. 2 shows an architecture of a tax administration system (TAS) converter in accordance with an embodiment of the invention.

FIG. 3 shows high level flow of TAS to AERS (Accenture Enterprise Revenue Solution) Rule Engine conversion in accordance with an embodiment of the invention.

FIG. 4 shows an architecture for converting a rules component in accordance with an embodiment of the invention.

FIG. 5 shows a high level flow for performing form rules conversion in accordance with an embodiment of the invention.

FIG. 6 shows a high level flow for performing back-end rules conversion in accordance with an embodiment of the invention.

FIG. 7 shows a data migration process in accordance with an embodiment of the invention.

FIG. 8 shows a tax administration system (TAS) converter process in accordance with an embodiment of the invention.

FIG. 9 shows a high level flow for converting a revenue accounting chart from a tax administration system (TAS) in accordance with an embodiment of the invention.

FIG. 10 shows a high level flow for converting a data component from a tax administration system (TAS) in accordance with an embodiment of the invention.

FIG. 11 shows a high level flow of a correspondence component from a tax administration system (TAS) in accordance with an embodiment of the invention.

FIG. 12 shows a high level flow for converting an interface component from a tax administration system (TAS) in accordance with an embodiment of the invention.

FIG. 13 shows a high level flow for converting a reporting component from a tax administration system (TAS) in accordance with an embodiment of the invention.

FIG. 14 shows TAS demographic table structures in accordance with an embodiment of the invention.

### DETAILED DESCRIPTION OF THE INVENTION

### Overview of Architecture

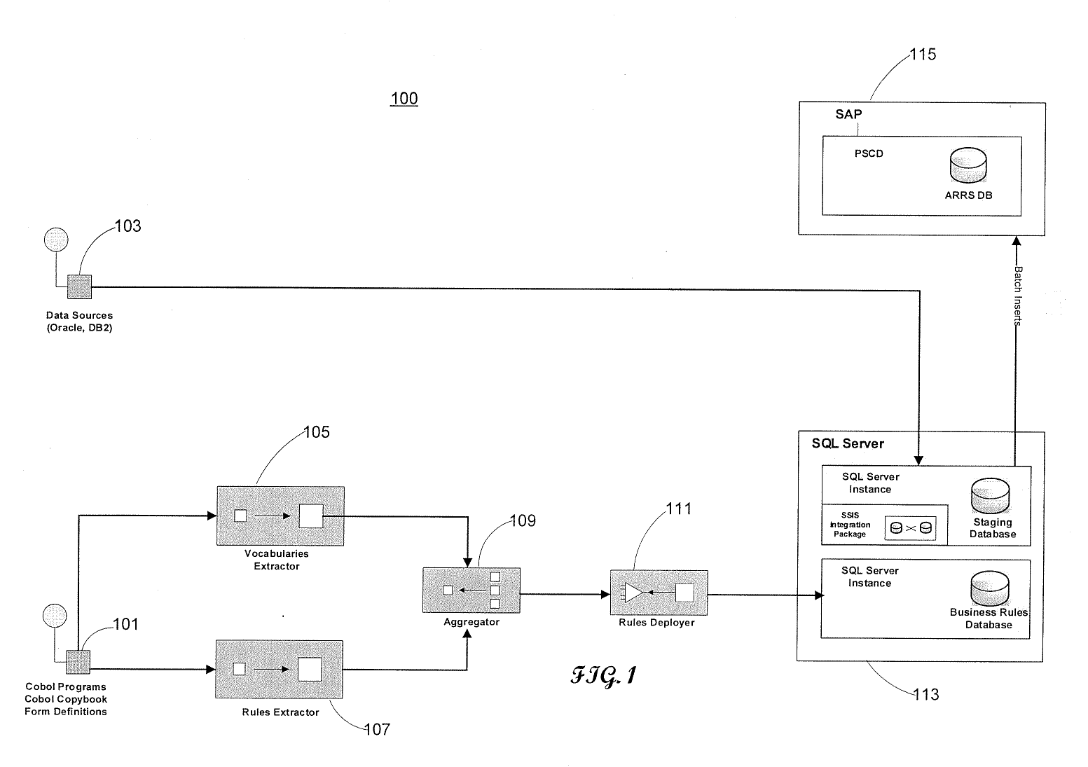

FIG. 1 shows an architecture 100 in which a legacy application (corresponding to COBOL programs 101 and data sources 103) is migrated to a designated application (corresponding to SQL server 113 and SAP® server 115) in accordance with embodiment of the invention. (SAP AG is the largest European software enterprise, with headquarters in Walldorf, Germany. SQL (Structured Query Language) is a computer language used to create, retrieve, update and delete data from relational database management systems. SQL has been standardized by both ANSI and ISO.) The Accenture TAS to AERS Migration Tool is intended to reduce the AERS (Accenture Enterprise Revenue Solution) development effort for these clients that already have an implementation of the Accenture TAS (Tax Administration System) system in place, thus providing a net competitive advantage. The first phase of the Accenture TAS to AERS Migration Tool development focuses primarily on business rules extraction and conversion, and legacy data migration. The client is expected to provide all files containing COBOL programs 101 pertinent to the definition of all forms to be processed. (COBOL is a third-generation programming language, and one of the oldest programming languages still in active use. Its name is an acronym for COmmon Business-Oriented Language, defining its primary domain in business, finance, and administrative systems for companies and governments. COBOL was initially created in 1959 by The Short Range Committee, one of three committees proposed at a meeting held at the Pentagon on May 28 and 29, 1959.) There are 3 files required:
Edit Module program
Line Item Information module
Filing Date program
   The client is expected to provide all data sources 103 containing data to be migrated to the AERS target database 115.

### Conversion Tasks

Based on the business requirements one can break down the business rules migration process into the following tasks:

1. Extract vocabulary items from source code
2. Create and deploy schema
3. Categorize extracted vocabularies
4. Deploy vocabularies to the Business Rules Engine database
5. Extract rules logic from source code
6. Correlate rules and vocabularies
7. Export extracted policies in the Business Rules Engine database

### 8. Test Policies

9. Publish and deploy Policies
10. Log processing statuses
The following discussion provides additional description of the above tasks to identify design considerations and trade-offs.
Step 1: Extract Vocabulary Items from Source Code

Currently the form definitions are contained only in COBOL source code 101. COBOL programs 101 are typically organized in sets of three files that combine to define a single Tax Form/Tax Year definition in the legacy FDF implementation. The file names are XnnnYYrr, where:
X=program time (E—line edits; L—Line item definition; F—filing dates)
nnn=form type code (specific to a client installation, we'll give you a full list as we move forward with the POC and DC code)
YY=tax year as in 05=2005
rr=revision number with 00 indicating the initial definition, 01, 02 . . . and so forth
   For example, the three files necessary for defining a Sales and Use Tax Monthly Return (form type=350) for 2005 would be:
E3000500.txt
L3000500.txt
F3000500.txt

With embodiments of the invention, one desires an optional synchronous interaction between the vocabulary extraction process and the user. This implies that the client waits until the vocabulary extractor 105 returns a status on the extraction process and optionally presents the user a comprehensive list of all extracted vocabularies. This includes extracting line item definitions, filing date definition and line edits from the source code provided.

### Step 2: Create and Deploy Schema

After the vocabulary is extracted from the source code and its structure established, a schema must be inferred from the XML created, strongly named then deployed to the GAC (Globally Assembly Cache).

### Step 3: Create Vocabulary Files

Once extracted from the source code, vocabularies must be categorized by types. They can be constants, XML elements, .NET components or database fields. The vocabularies must then be used to populate the vocabulary schema understood by the rules engine.

### Step 4: Deploy Vocabularies to the Business Rules Engine Database

The vocabulary XML created in step 3 is imported into the rules engine database, and vocabularies are published to be made accessible by the business rules that are subject to use them.

Step 5: Extract Rules Logic from Source Code

Rules are contained in the line edits COBOL code. The rules extractor 107 extracts the rules and reorganizes them in a structure that renders the logic easier to manipulate and map to the structure expected by the rules engine. After the base rules are extracted, rules edits are then extracted from the code and applied to the extracted rules.

### Step 6: Correlate Rules and Vocabularies

In this process, vocabularies used by the extracted business rules must be correlated to the vocabularies that have been extracted. This process is handled by aggregator component 109. Some required fields may be missing and more information may be required from the client. As a result rules extractor 107 may need to notify the client of the missing vocabularies.

### Step 7: Export Extracted Policies to the Business Rules Engine Database

Once extracted from the source code, rules must be grouped by policy. The intention is to have one policy per form and per year. The naming convention for policies would be “TAS_nnnYYrr”.

### Step 8: Test Policies

Each policy version may be tested during development, or even after it is published, deployed, and running. Tests are performed after policies are saved, but not yet deployed. It may be more difficult to modify a rule set after it is deployed.

### Step 9: Publish and Deploy Policies

After policies are tested, they are typically deployed. It is only after deployment that a policy with its rule sets can be accessed by external applications.

### Step 10: Log Processing Statuses

All steps performed by the TAS Converter (e.g., converter 200) are captured and included into the log that is sent back to the user. If there are multiple acknowledgements, they must be concatenated together. One may use aggregator component 109 to collect and store individual responses and pertinent information related to each step in the conversion process for the rules conversion and data conversion. Aggregator 109 subsequently creates a single log distilled from the individual messages and pieces of information captured.

### Data Migration

With embodiments of the invention, DB2 to SAP data migration (corresponding to data source 103 to SAP server 113) is performed through SQL Server Integration Services (SSIS). Transformation and ETL (Extract, Transform, Load) are handled by SSIS Bulk insert to SAP server will be performed through an SAP program using iDocs and performing validation before the data is bulked inserted into Public Sector Collection & Disbursement (PSCD). (SAP Public Sector Collection & Disbursement provides return filing, payment processing, collections, customer assistance, and financial management. SAP PSCD can be used in different scenarios, including Student Accounting.)

### Other Considerations

With embodiments of the invention, one is includes error handling. An additional architecture component acts as a gatherer of response information. As a result, one form of error handling is to retry the action. If the conversion or transfer cannot be performed, the user needs to be notified adequately. The TAS Converter should provide the ability to change the export parameters, and the user should simply be able to retry the request.

### Implementation Strategy

One may use a synchronous interaction between all components to keep the interaction model as simple as possible. Simplicity is brought by the fact that it may be easier to test and debug because the user executes within a single thread of execution.

### Summary

The rules migration tool supports the following aspects, which will be discussed in further detail.
Reduce the Cost of an ITS upgrade
Reduce the Risk of an ITS upgrade
Reduce the Time of a Core upgrade
Quickly convert existing forms rules and back-end business rules
Central rules repository
Rules are grouped by form type—Easier to retrieve
Easier to manage
Forms Rule Conversion extracts the existing forms rules and removes the need for a green fields form definition effort that usually accompanies an ITS upgrade.
The plan is to extract also TAS back-end business rules surrounding penalty and interest and refunds
The goal is to extract these rules and unite them into a common rules set, translate and standardize the rules for import
Once the rules are standardized, the rules can be imported to BizTalk™ to satisfy the rules execution
The back-end rules within TAS are embedded at the application and database levels. This effort will unite those layers, transfer the rules to a common Business Rules language and import to BizTalk.
Creates a data structure from the meaningful elements extracted from the COBOL code
Rules created through FDF and forward generated as COBOL are extracted and converted
The following areas will be covered by the TAS converter:
   Data Conversion
   Form Rules Conversion
   Interface Conversion
   Correspondence Conversion
   Back-end Rules Conversion
   Migration of Revenue Accounting Chart of Accounts
   Conversion of Existing TAS Reports

With embodiments of the invention, it is possible to use components of the TAS converter outside of the context of the Accenture Tax Administration System. For instance, the rules converter contains generic capabilities that allow for extracting rules from any properly formatted COBOL application. As long as the rules are stored in a defined area of the legacy application, the TAS converter for rules conversion would be able to extract and convert the rules for non TAS applications. A similar situation exists for the TAS data converter. As the TAS data converter extracts the database components from TAS into a denormalized data and then loads that information into the target application, it is possible to simply apply the denormalized data extraction against any legacy data set. Once the data is in the predetermined format, the TAS converter can load the information into the target application using the predetermined routines and processes.

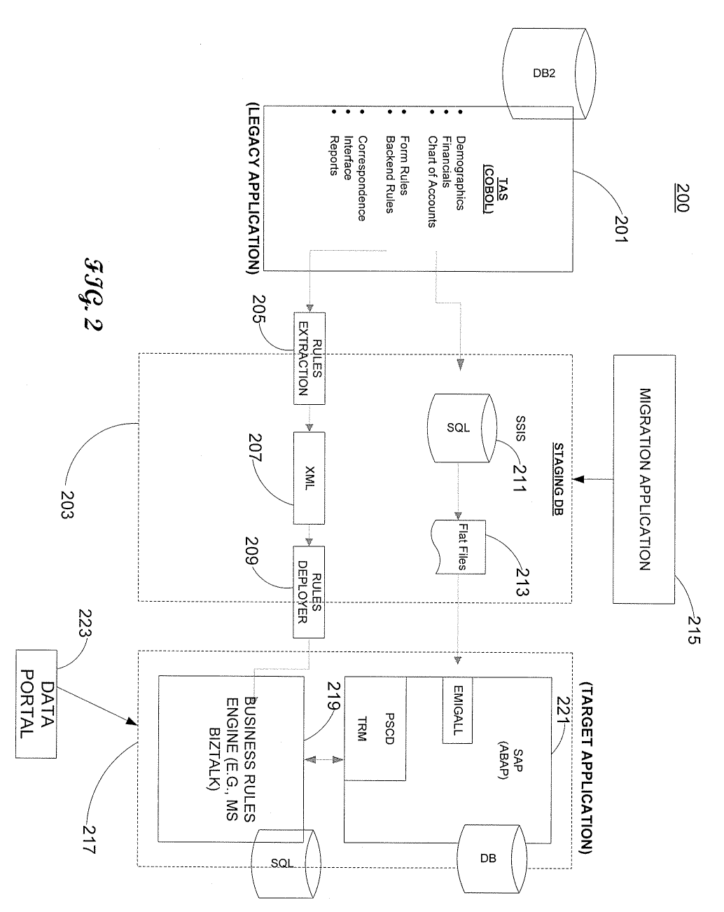

FIG. 2 shows an architecture of Tax Administration System (TAS) converter 200 in accordance with an embodiment of the invention. Legacy application 201 (e.g., a tax administration system) includes a number of components, including a form rules component, a backend rules component, a demographics component, a financials component, a chart of accounts component, a correspondence component, an interface component, and a reports component. Migration application 215 converts and migrates the legacy components to target application 217 through staging database 203.

A rule component may include both the form rules component and the backend rules component. A form rule is associated with rules for a corresponding line of a form while a backend rule is associated with rules for further processing of information in the form lines. For example, a backend rule may be related to penalty, interest, and refunds calculations in accordance with the information provided by a tax form and the application of policy within the agency. A data component may include the demographics component, the financials component, and the chart of accounts of component. The demographics component is associated with the demographic information of an individual, business, or related entity (e.g., a taxpayer). The financials component is associated with previously filed forms of previous years or open periods of tax obligation, and the chart of accounts component indicates the accounts that are used to consolidate financial transactions and distribution of collected revenue to different government agencies.

The rules components are extracted from legacy application 201 and are generated to intermediate expressions (e.g., XML file 207) by rules extractor 205. Rules deployer 209 converts the intermediate expressions to target rules and deploys the target rules on business rules engine (BRE) 219, which is contained in target application 217. Business rules engine 219 can consequently execute the target rules when target application 217 is operating.

With embodiments of the invention, business rules engine 219 utilizes BizTalk™ Server, which is Microsoft's central platform for Enterprise Application Integration (EAI) and Business Process Management (BPM) and embodies the integration and automation capabilities of XML and Web Services technologies. BizTalk Server functions as a process execution engine and as a multi-transport hub for messaging and document transformations. It is a Windows™ Server System product that helps customers efficiently and effectively integrate systems, employees and trading partners.

The data components are extracted from legacy application 201 into SQL database 211 and converted into an intermediate data element. The intermediate data element is then converted and migrated from flat file 213 to SAP server 221 executing ABAP, which is contained in target application 217. ABAP (Advanced Business Application Programming) is a high level programming language created by SAP. It is currently positioned, alongside the more recently introduced Java, as the language for programming SAP's Web Application Server.

While not explicitly shown in FIG. 2, converter 200 may also convert and migrate the correspondence, interface, and reports components to target application 217. There are two types of correspondence conversion covered by the invention. The first is the conversion of correspondence templates that generically exist within the legacy system. These templates will undergo a similar extraction and loading process as the data and rules. Basically, the correspondence templates are extracted and placed into the template generation area of the target application. Likewise, a simple mapping exercise converts the pre-existing define data elements from the legacy application to XML references in the target system. Second, correspondence includes the conversion of historical documents within the legacy system. Taxpayers are periodically sent notices or correspondence from the legacy system. Rather than save the entire document, TAS saves the correspondence template and the data elements that went in to that correspondence. Historical correspondence can be converted and saved within the target application for future reference and access.

The report and interface conversions operate off of a similar concept. Given that the data structure in the underlying legacy application (TAS) is consistent across implementations it is possible to match the data elements from the legacy system to the target system and regenerate the interfaces and reports in the context of the target system. This can either be done as a manual matching process or automated through standard services and processes. The reports component is associated with reports that are generated by legacy application 201.

Target application 217 may obtain other data (e.g., a current year's tax form) through data portal 223. The other data may be processed in concert with the rules components and data components migrated from legacy application 201.

While the architecture shown in FIG. 2 illustrates a migration from a legacy Accenture Tax Administration System to a SAP server, embodiments of the invention also support the migration to other target systems.

### High Level Flow for Converting Rules

### First Embodiment

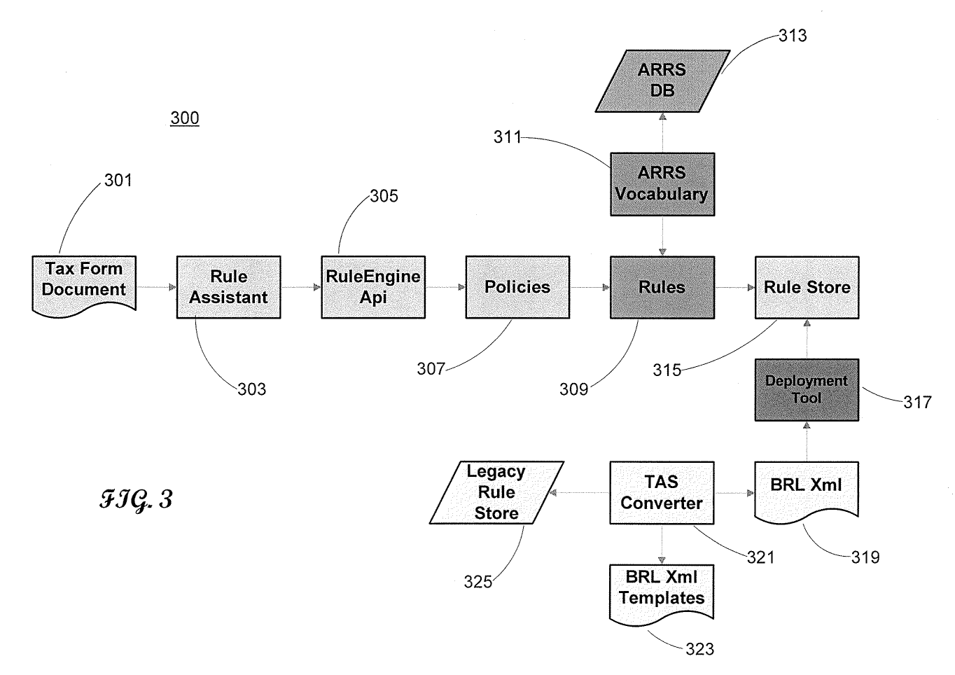

FIG. 3 shows high level flow 300 of TAS to AERS Rule Engine conversion in accordance with an embodiment of the invention. Flow diagram 300 shows an overall high level flow of the legacy rule engine architecture in order to:
Convert COBOL Driver program to BizTalk™ (components 319-325). This is a one-time process during which all data parts making up the business rules in Legacy Rules Store (component 325) are identified and extracted by TAS Converter (component 321), converted to Business Rule Language XML to make it comprehensible by the BizTalk Rules Engine, then migrated to the Rules Store (component 315) by the Rules Deployment Tool (component 317).
Expose business rules to perform validation (components 309-313). These are the business rules that have been extracted in the one-time process described above. These rules are organized in an ordered fashion, grouped by specific tax forms they relate to. AERS Vocabularies have also been automatically built during the extraction/conversion process. Their purpose is to present data elements composing the rules, whether they originate from database queries, XML elements or classes, in a friendly, English-like syntax.
Process Tax Forms validation. Tax form input 301 is submitted to the application using the Rule Engine API, (called Rule Assistant corresponding to component 303). Rule Assistant 303 is the driver component that has the knowledge about which policy (component 305) to call based on the tax form input and a pattern-matching logic provided by the BizTalk Rules Engine API (component 307). A policy is a collection of rules. The following are different types of policies required for this conversion.
   Simple Edits
   Cross Validation
   Row edits
   Exit Routines
   Transaction Application
      There are two possible ways to structure policies.
Single policy for each of the above types.
Multiple policies based on tableref or tableid.
   The following components are needed to convert this application.

### Common Vocabulary.

Vocabulary is a list of predicates encapsulating business requirements in English like syntax, even though BRE supports three different bindings. Net, SQL and Xml, .Net binding is most suitable for TAS scenario. (Typically, one uses a .Net class based vocabulary, where the vocabulary is found to an abstract class.) An implementation typically allows reuse of the rules and policies by different LOB. This component is often called TAS Vocabulary.

### XML Schema for Facts

This allows the consolidation of various independent data elements into one or more XML documents. The .XSD schema will be converted to .Net class using XSD.exe. This .Net class is used as a fact for the rule engine (not xml directly). This schema is called TASTaxFormDocument.

### Listing All the Policies and Sequence of Policy Execution

One identifies the current data flow and sequence of policy execution. This is encapsulated in a business component. This component is the primary Data Object for communicating with rules. This component is called TASRuleAssistant.

### Automatic Migrating of Legacy Rules

These components is called TASRulesConverter. Manual restatement of a smaller number of rules typically cannot be automatically uploaded.

### Algorithm for Migrating Legacy Rules:

Embodiments of the invention support the following aspects:
1. Identify the patterns in existing legacy rules, these patterns can be rules and constructs that are repeating often.
   Example:
   1.1. If EffectiveDate between ‘01-01-1900’ and ‘01-01-2003’.
   1.2. If ColumnValue in List “1|2|3|4”.
2. Create vocabulary to support the above patterns.

```
public abstract class TASVocabularySimpleEdits
{
  public abstract bool inList(TASConverter.DriverFactRuleTypes context,
              string list);
  public abstract bool between(TASConverter.DriverFactRuleTypes
              context, string minValue,
              string maxValue);
  public abstract bool IsValidMask(TASConverter.DriverFactRuleTypes
              context, string mask);
  public abstract bool addErrorID(string errorID);
}
```

3. Build a BRE vocabulary using the above abstract class. A sample vocabulary is provided along with this document.
4. Create a template policy with at least one rule for every abstract method.
5. Create sample template rules using various and, or constructs. If nested “and” or “or” are required then create rules using those constructs.
6. Export the template policy to .XML using “Rule Engine Deployment Wizard”. Understand the structure of the exported XML policy.
7. Break the exported policy XML of into various smaller files, each file containing a unique pattern.
   Example:
      To add action called addErrorID:

```
<function>
    <vocabularylink uri=“534f50ac-8e6c-4bfe-877f-4e75a0ecf4e2”
    element=“503f5d7e-c85c-4017-969c-938c291b1fca” />
    <classmember classref=“TASVocabulary”
      member=“addErrorID” sideeffects=“true”>
        <argument>
            <constant>
                <string>{0}</string>
            </constant>
        </argument>
    </classmember>
</function>
    To create version number and main header:
<brl xmlns=“http://schemas.microsoft.com/businessruleslanguage/2002”>
    <ruleset name=“TAS_3000500”>
        <version major=“{0}” minor=“{1}” description=“”
modifiedby=“RESBT2404\Administrator”
date=“2007-02-13T16:20:35.7514080-05:00”/>
    </ruleset>
    <configuration />
</brl>
    To find if the column is in a given list:
<predicate>
  <vocabularylink uri=“534f50ac-8e6c-4bfe-877f-4e75a0ecf4e2”
  element=“2c6fb474-f735-45b5-b9dd-8d60c0f90a10” />
  <classmember classref=“TASVocabulary”
  member=“inList” sideeffects=“true”>
  <argument>
      <reference>
      <vocabularylink uri=“f5029754-44db-440c-8820-8d55eedfd7b1”
          element=“7b218bc0-4ac9-4ee4-b3b9-7606aef40626” />
          <classref ref=“TASConverter.DriverFactRuleTypes” />
      </reference>
    </argument>
    <argument>
      <constant>
        <string>{0}</string>
      </constant>
    </argument>
  </classmember>
</predicate>
```

One should note that “{” and “}” brackets are used as a place holder for text substitution using C# language. The actual value from the legacy rule will replace the curly braces.
8. After creating patterns, it is a procedural matter of walking the existing legacy rule base and replacing the legacy values in the templates and then composing the templates into various rules and policies as shown in the following code.

```
class MigrateRulesToBre
{
    /// <summary>
    /// The main entry point for the application.
    /// </summary>
    [STAThread]
    static void Main(string[ ] args)
    {
      string myConnString = ConfigurationSettings.AppSettings[″TASMetaData″];
        // READ LEGACY DATA
    string mySelectQuery = ″SELECT * FROM TCSTV010 WHERE MINVAL != ″″ +
                ″ OR MAXVAL != ″ OR VALLIST != ″ ″;
      SqlConnection myConnection = new SqlConnection(myConnString);
      SqlCommand myCommand = new
SqlCommand(mySelectQuery,myConnection);
      myConnection.Open( );
SqlDataReader myReader;
myReader = myCommand.ExecuteReader( );
// REPLACE ″1″, ″2″ AS MAJOR AND MINOR VERSION OF THE POLICY
Console.WriteLine(getMain(″1″,″2″));
// GET THE BINDING INFORMATION
Console.WriteLine(getBindings( ));
while (myReader.Read( ))
{
    // READ THE FIRST LEGACY RULE
    string ruleName = myReader[″RULENAME].ToString( ).Trim( ) ;
    string elementName = myReader[″ELEMENT″].ToString( ).Trim( );
    string messageNum = myReader[″MSGNUM″].ToString( ).Trim( );
    sting dataType = myReader[″DATATYPE″].ToString( ).Trim( );
    string minVal = myReader[″MINVAL″].ToString( ).Trim( );
    string maxVal = myReader[″MAXVAL″].ToString( ).Trim( );
    string valList = myReader[″VALLIST″].ToString( ).Trim( );
    string acf2res = myReader[″ACF2RES″].ToString( ).Trim( );
    string ruleVERS = myReader[″RULEVERS″].ToString( ).Trim( );
    StringBuilder ruleText = new StringBuilder( );
    string ruleTag = String.Format(″<rule name=\″{0}\″
                    priority=\″0\″ active=\″true\″>″,
            ruleName);
    ruleText.Append(ruleTag);
    /* Here is an example of BRE RULE generated
        if COLNAME = NRC_CAT_CD
          and not SIMPLEEDITFACTS is INLIST 1|2|3|4
        then
        ERROR NUM = TASMA945.
        where COLNAME is the ELEMENT,
        and SIMPLEEDITFACTS has the context information like column
type,
    column value in it.
      */
      ruleText.Append(″<if><and>″);
      // Add the COLNAME check. This is common for all the rules
      ruleText.Append(getEqual(″COLNAME″,elementName));
      // if MINVAL or MAXVAL is present then create a rule using “between”
      ruleText.Append(″<not>″);
      if (minVal != ″″ || maxVal != ″″)
      {
          ruleText.Append(getBetween(minVal,maxVal));
      }
      else
      // if “valList” is present then create a rule using “inList”
      if (valList != ″″)
      {
          ruleText.Append(getInList(valList));
      }
      ruleText.Append(″</not>″);
      ruleText.Append(″</and></if>″);
        ruleText.Append(″<then>″);
        // ADD RULE ACTION BASED ON THE MSGNUM
        ruleText.Append(AddErrorID(messageNum));
        ruleText.Append(″</then>″);
        ruleText.Append(″</rule>″);
        Console.WriteLine(ruleText.ToString( ));
      }
      Console.WriteLine(″</ruleset></brl>″);
      // always call Close when done reading.
      myReader.Close( );
      // Close the connection when done with it.
      myConnection.Close( );
    }
    static string AddErrorID(string errorID)
    {
        using (StreamReader sr = new
StreamReader(″TemplateAddErrorID.xml″))
        {
            string templateText = sr.ReadToEnd( );
            return String.Format(templateText,errorID);
        }
    }
    static string getBindings( )
    {
        using (StreamReader sr = new StreamReader(″TemplateBindings.xml″))
        {
            string templateText = sr.ReadToEnd( );
            return templateText;
        }
    }
    static string getBetween(string first,string second)
    {
        first = first.Trim( );
        second = second.Trim( );
        using (StreamReader sr = new StreamReader(″TemplateBetween.xml″))
        {
            string templateText = sr.ReadToEnd( );
            return String.Format(templateText,first,second);
        }
    }
    static string getInList(string list)
    {
        list = list.Trim( );
        using (StreamReader sr = new StreamReader(″TemplateInList.xml″))
        {
            string templateText = sr.ReadToEnd( );
            return String.Format(templateText,list);
        }
    }
    static sting getMain(string majorVersion,string minorVersion)
    {
        using (StreamReader sr = new StreamReader(″TemplateMain.xml″))
        {
            string templateText = sr.ReadToEnd( );
            return String.Format(templateText,majorVersion,minorVersion);
        }
    }
    static string getEqual(string lhs,string rhs)
    {
        lhs = lhs.Trim( );
        rhs = rhs.Trim( );
        using (StreamReader sr = new StreamReader(″TemplateEqual.xml″))
        {
            string templateText = sr.ReadToEnd( );
            return String.Format(templateText,lhs,rhs);
        }
    }
}
```

### High Level Flow for Converting Rules

### Second Embodiment

### Authoring Policies and Vocabularies

There are several ways to author policies and vocabularies. The most common way, and the one used exclusively by the business analysts who are the main target of rule-based processing, is to use the Business Rule Composer tool. The following discusses authoring for programmers. These techniques enables one to write applications that create rules dynamically and lets one create tools for application development, as well. One can author rulesets outside the composer in two ways. These approaches are primarily for tools development and system administration. The first uses XML documents. This is the approach BizTalk uses to export and import policies and vocabularies. The other is through .NET APIs and programming.

### BRL-Syntax XML Documents

Programmers having experience with database administration may have conducted bulk data dumps of a relational database to a text file. These have usually been flat files in formats such as CSV. XML offers more structure, so it should not be surprising that that is how BizTalk gets rules data in and out of SQL Server stores. It is also used to save policies and vocabularies in file stores outside SQL Server. Although it is not common, it is possible to run a rules-based application entirely with file stores. The XML syntax Microsoft devised for this task is known as the Business Rules Language, or BRL. Please note that the namespace for BRL is declared as http://schemas.microsoft.com/businessruleslanguage/2002. This is a namespace proprietary to Microsoft. Although policies and vocabularies are exported to separate documents from the Business Rule Composer, both documents have the same document element, brl. Listing A shows the beginning of a policy file, known here as a ruleset. As follows, Listing A illustrates a partial ruleset document showing version, configuration, and binding information.

```
<brl xmlns=“http://schemas.microsoft.com/businessruleslanguage/2002”>
    <ruleset name=“RFP”>
        <version major=“1” minor=“4” description=“”
            modifiedby=“myserver\user”
            date=“2004-02-15T00:29:02.6381024-05:00” />
        <configuration>
            <factretriever>
                <assembly>
                    DbFactRetriever, Version=1.0.1505.34508,
                    Culture=neutral,
PublicKeyToken=d4e488d64aff1da4
                </assembly>
                <class>
    Que.BizTalk.RFP.myFactRetriever.RFPDbFactRetriever
                </class>
            </factretriever>
        </configuration>
        <bindings>
            <xmldocument ref=“xml_0”
doctype=“RFPEstimateXML.RulesRFP”
                instances=“16” selectivity=“1” instance=“0”>
                <selector>
                    /*[local-name( )=‘RFP’ and namespace-
                        uri( )=‘http://RFPEstimateXML.RulesRFP’]
                </selector>
                <schema>C:\RulesRFP.xsd</schema>
            </xmldocument>
            <datarow ref=“db_1” server=“myserver\Consulting”
                    dataset=“Consulting” table=“Rates”
                    instances=“16”
                    selectivity=“1” isdataconnection=“true”
                    instance=“0” />
        </bindings>
```

One should notice that the version element declares the major and minor version of the policy, as well as who modified the policy and when. Version control is very important in rules development. Moving down to the configuration element, one sees that the policy is configured to use a database fact retriever. The assembly and class information is specified. The last area to look at is the bindings section. The first child of the bindings element binds an XML document to the policy as a fact source by specifying the .NET-style qualified class name, the XPath expression that selects the root of the document based on local name and namespace, and the physical file that specifies the schema. Because the last item is a file path, one should transfer the file to the new server when exporting a ruleset.

The exemplary document goes on to specify rules using an XML structure that allows one to express conditions and actions in prefix notation. Listing B depicts a rule with one compound condition and three actions. The last two actions have been edited for space. As follows, Listing B shows a business rule in friendly form:

If Hours is greater than 160 AND Scam equals Service

### Then

Approved True
Comments Discount Approved
Cost (0.9*(Hours*Hourly Rate))

One should note how the rule is anchored by the rule element. The name, priority, and status of the rule are given there using attributes. Everything below the rule expresses the structure of the rule. The condition is contained within the if element. True to the prefix notation, the AND element (which is the logical operator combining the two conditions) comes first. The greater than operator for the first predicate comes next. The vocabulary link element identifies this operator in the built-in predicates vocabulary. From there, we bind to a fact in this case, the Hours field in our XML document This forms the left hand side (lhs) of the predicate. The right hand side (rhs) is a constant; the decimal value 160. As follows, Listing C illustrates a rule definition fragment from the ruleset document:

```
<rule name=“DiscountRate” priority=“0” active=“true”>
  <if>
    <and>
      <compare operator=“greater than”>
        <vocabularylink uri=“3f0e9bcc-6212-4e6a-853c-e517f157a626”
    element=“b276a0f4-12d9-4380-b242-135bbfc5e287” />
        <lhs>
          <function>
            <vocabularylink uri=“8a4906c8-3797-4ae6-a9b6-
            864c23c81438”
      element=“728b3a0b-b270-4cfa-aac6-b24e3aaad8dd” />
            <xmldocumentmember xmldocumentref=“xml_0”
type=“decimal” sideeffects=“false”>
                <field>*[local-name( )=‘Hours’ and namespace-
uri( )=”]</field>
                <fieldalias>Hours</fieldalias>
            </xmldocumentmember>
          </function>
        </lhs>
        <rhs>
          <constant>
            <decimal>160</decimal>
          </constant>
        </rhs>
      </compare>
      <compare operator=“equal”>
        ... <!-- details omitted for space -->
      </compare>
    </and>
  </if>
  <then>
    <function>
      <vocabularylink uri=“8a4906c8-3797-4ae6-a9b6-864c23c81438”
    element=“89745202-17d8-412f-bfa3-382d67111a91” />
      <xmldocumentmember xmldocumentref=“xml_0” type=“boolean”
sideeffects=“true”>
        <field>*[local-name( )=‘Approved’ and namespace-
        uri( )=”]</field>
        <fieldalias>Approved</fieldalias>
        <argument>
          <constant>
            <boolean>true</boolean>
          </constant>
        </argument>
      </xmldocumentmember>
    </function>
    <function>
      ... <!-- details omitted for space -->
    </function>
    <function>
      ... <!-- omitted for space -->
    </function>
  </then>
</rule>
```

One may continue in this fashion until one reaches the then element, which anchors the actions section of the rule. The first action, from Listing B, is to assign the Approved field of an XML document to the Boolean value true. The assignment function takes an XML document binding and a single argument, the value. The vocabulary links in Listings A and C associate the ruleset document with the two built-in vocabularies (functions and predicates) and a vocabulary of our own devising. Listing D shows a portion of our vocabulary. As with the ruleset document, one begins with a brl element. This is followed by the vocabulary element with its version control information. From there, one has a series of vocabulary definition elements. Each one binds a friendly name to a database column or XML document field. As follows, Listing D illustrates a vocabulary BRL document.

```
<brl xmlns=“http://schemas.microsoft.com/businessruleslanguage/2002”>
    <vocabulary id=“8a4906c8-3797-4ae6-a9b6-864c23c81438”
    name=“RFP”
                uri=“” description=“”>
        <version major=“1” minor=“1” description=“”
            modifiedby=“myserver\user”
            date=“2004-02-14T21:57:55.6504144-05:00” />
        <vocabularydefinition id=“693a705f-a6a4-4e37-92b9-
        06a52a2553c7”
            name=“SvcName” description=“”>
            <bindingdefinition>
                <databasecolumnbindingdefinition
                column=“rate_name”
                      type=“string”>
                    <databaseinfo server=“myserver\Consulting”
                        database=“Consulting” table=“Rates”
                        connection=“true” instance=“0” />
                </databasecolumnbindingdefinition>
            </bindingdefinition>
            <formatstring language=“en-US” string=“SvcName” />
        </vocabularydefinition>
        <vocabularydefinition id=“0c2f3a3a-e598-4c96-9bb2-
        0b0797e9ef3e”
            name=“Cost” description=“”>
            <bindingdefinition>
                <documentelementbindingdefinition
                    field=“*[local-name( )=‘Estimate’ and
namespace-uri( )=”]”
                    fieldalias=“Estimate” type=“decimal”>
                    <documentinfo schema=“C:\RulesRFP.xsd”
documenttype=“RFPEstimateXML.RulesRFP”
                              selector=“/*[local-name( )=‘RFP’
and
          namespace-uri( )=‘http://RFPEstimateXML.RulesRFP’]”
                              selectoralias=“/*[local-
name( )=‘RFP’ and
        namespace-uri( )=‘http://RFPEstimateXML.RulesRFP’]”
                              instance=“0” />
                    <argument position=“0”>
                        <valuedefinitionliteral type=“decimal”>
                            <decimal>0</decimal>
                        </valuedefinitionliteral>
                    </argument>
                </documentelementbindingdefinition>
            </bindingdefinition>
            <formatstring language=“en-US” string=“Cost {0}”
                          delimiter=“{[0-9]+}”>
                <argument position=“0”>
                    <valuedefinitionliteral type=“decimal”>
                        <decimal>0</decimal>
                    </valuedefinitionliteral>
                </argument>
            </formatstring>
        </vocabularydefinition>
        ...
    </brl>
```

The first definition is a binding between the name SvcName and the column rate_name in the Rates table of the Consulting database. One first names the column in the databasecolumnbindingdefinition element and then provides the database and table information in the databaseinfo element. The second definition shown is an association of the name Cost with the Estimate field in an XML document. The documentelementbindingdefinition element denotes a binding to an element in an XML document, not a binding to the XML document element. After providing a suitable XPath expression in that element to select the field, the documentinfo element provides the .NET-style type of the document, the physical schema file, and the XPath explicitly locating the document element of this particular document class. As one can see, authoring rulesets and vocabularies in BRL is an exacting task. Typically, one would never want to do this by hand, but the schema exists. It could conceivably be used to modify an existing export file. For example, one might use XPath to locate and fix up schema file paths to reflect the target server environment. One could also use XSLT to display rulesets as HTML by way of providing formal documentation.

### .NET APIs for Rule-Based Application Development

The other way to author rules is programmatically, using the classes of the .NET APIs for rules development. The classes that are needed are found in the Microsoft.RuleEngine package. This is implemented in the Microsoft.RuleEngine.dll assembly found in the BizTalk Server 2004 installation folder. The basic approach is to create instances of the LogicalExpression class, representing the condition portion of a rule, an instance of ActionCollection to hold the actions for the rule. When both objects are properly set, one adds them to an instance of the Rule class. The rule is then added to a RuleSet object. When one wants to persist the rules, one uses one of the FileRuleStore or SqlRuleStore classes. To run a ruleset under development, one needs a PolicyTester object. After the ruleset is in production, one can use the simpler Policy class. These classes are just a few of the many classes in the rule development APIs, but they are the principal classes used for authoring. If one expects to create authoring tools and work with the .NET classes extensively, one needs to study the product documentation in detail. However, one can consider the major classes used in rule-based application development.

### Rule Development APIs

The rules APIs belong to two packages. The main package is Microsoft.RuleEngine, implemented in Microsoft.RuleEngine.dll. The other, Microsoft.BizTalk.RuleEngineExtensions, adds three classes to extend the rule-based system. Both assemblies are located in the BizTalk Server installation folder. These packages contain literally dozens of classes, but there are a few that are essential. One should consider these core classes, e.g., policy. Another class, PolicyTester, may take its place during development, but policy represents a completed, production knowledge-based system available for execution. To execute, it should be configured, and it should load a ruleset. The RuleSet class, in turn, loads and uses one or more instances of the Rule class. Rule objects, as previously discussed, contain LogicalExpression objects and Action objects. As important as rules are, though, one cannot have a knowledge-based system without facts. Instances of policy use classes one develops that implement the IFactRetriever interface. This is the interface that manages long-term facts and the fact-base. When a policy has loaded rules and facts, it is ready for execution by the rule engine. A rule engine that could hold policies only in memory would be an interesting lab tool, but may not be suitable for enterprise applications. The abstract class RuleStore develops the semantics of a durable store for policies and vocabularies. It is implemented by two derived classes, FileRuleStore and SqlRuleStore. As the names imply, FileRuleStore uses disk files for storage and SqlRuleStore uses a SQL Server relational engine.

### Policy

A BizTalk policy is a ruleset, and there is a class corresponding to the BizTalk rule engine, but the policy class is a useful encapsulation of a number of things. It shields programmers from the nuts and bolts of working with rule stores and the rule engine. As such, one should configure a policy instance and work with it as if it were the rule engine itself. It loads an instance of RuleSet, so one can have a distinction between the policy class and the generalized concept of a BizTalk policy. The policy class has two constructors. One takes a string whose value names the policy you want to work with. The other takes the same parameter and adds two System.Int32 parameters for the major and minor policy version numbers. Any policy loaded through the policy constructor must be deployed in the rule store. Another class, PolicyTester, is very similar in its interface to Policy, but it has additional constructors that lets one load published policies and policies from other servers. Policy, in contrast, works with the local store and is concerned with production-ready rulesets. Policy has four public properties. MinorRevision and MajorRevision collectively define the version number of the Policy instance. PolicyName is the name of the policy. RuleSetInfo is a class that repeats the preceding information and adds data regarding who saved the policy and when. All four properties are read-only. The policy class has one major public method: Execute. This method has four overloaded forms. The purpose of this method is to load facts into the policy and apply the ruleset to them. The first form takes a System. Object parameter, which is some instance of a class, represents a fact in the system. The second form takes an array of such parameters. The remaining forms repeat this pattern (single object and array of objects), but add a second parameter, an instance of an object implementing the IRuleSetTrackingInterceptor. This interface is used to implement a debugging system for the rule engine.

### RuleSet

This class has an imposing eight versions of its constructor. The first takes a string parameter that names the ruleset. Unlike policy, this does not mean that the class loads the named ruleset from the store. It typically initializes a new instance of the class and gives it the specified name. There is another constructor that takes a name and a version number and performs the same initialization. There are two more versions of the constructor that take the same parameters and add an object of the type System.Collections.ICollection. This is a collection of rules to compose the ruleset. The remaining versions repeat all that we have seen, but also add a final parameter of the type VocabularyLink. This parameter draws in the vocabulary that provides the ruleset with its friendly names and specific fact bindings. The class has six properties, of which three are of particular importance to programmers. These are explained in Table 1.

TABLE 1
IMPORTANT PROPERTIES OF THE RULESET CLASS

| Property | Meaning |
|---|---|
| ExecutionConfiguration | Read/write property for an instance of a class, |
| | RuleSetExecutionConfiguration, that manages |
| | fact retrievers, other objects controlling rules |
| | execution, and parameters for memory and |
| | loop size. These factors govern the execution |
| | of rules in the rule engine. |
| Rules | Read-only RulesDictionary object. This class |
| | collects the rules in the ruleset. |
| VocabularyLink | Read/write instance of the class of the same |
| | name. This property associates the ruleset with |
| | the names and bindings to facts. |

### Rule

This is the class you will use if you are building rulesets dynamically in an application. One might do this to build tools, or one might use it to automatically generate rulesets in which one has a known set of basic rules that include values that change regularly. In that case, one could regenerate the ruleset by drawing the values from an application or database and creating the rules programmatically. There are six constructors for this class. The first takes a System.String naming the new rule. This does not load a rule from any store. It typically creates an empty rule object and gives it a name. The next takes a name parameter and adds a VocabularyLink object as the second parameter. This constructor also gives one an empty object, but now one has a link to a name that one might use in the constructed rule. The remaining constructors build complete rules based on the parameters passed to the constructor. The first constructor of this group takes a System.String for the name, a LogicalExpression object for the rule condition, and an ActionCollection object for the actions. The next form takes the name parameter, a System.Int32 representing the priority for the rule, and then the LogicalExpression and the ActionCollection objects. The last two constructors repeat the two forms, as previously discussed, and add a VocabularyLink object at the end. The first of these two takes a name, condition, actions, and the link. The final form takes a name, priority, condition, actions, and the link. The Rule class has six properties, all of which are read/write. The properties describe the parts and status of the rule object. Actions is an ActionCollection containing the rule's actions. Active is a Boolean variable, which indicates whether the rule is active or dormant. Conditions is a LogicalExpression. Despite the name, a rule has only one condition, but it may be a compound expression. Name is a String that must be unique within the ruleset. Priority is an Int32 and it has an interesting range of values. The larger the value, the higher the priority. Zero (0), though, is both the default and the middle value. VocabularyLink is both the name of the final property and its type. It establishes a link between the rule and a domain-specific definition. The class has just one method, Clone. It produces a deep copy of the rule. It is a quick and convenient way to generate a large number of similar rules. After calling Clone, one can modify those parts of the rule that differ from the original.

### LogicalExpression

One can proceed into the internal workings and components of a rule. LogicalExpression represents the rule condition. It has a single constructor that takes no parameters and creates an empty condition object. This class has two properties. The first, Type, is a read-only property of the System.Type class. VocabularyLink is a read/write property that is typed as an object of the class with that name. This class, like Rule, has a single method, Clone, that makes a deep copy of the condition. These are all the properties and methods of the class. Conspicuously absent is any sort of method for building the logical expression itself. It turns out there are classes representing all the predicates, such as NotEqual, and classes for the three logical operators to make compound expressions or their negation: LogicalAnd, LogicalOr, and LogicalNot. Using these in combination with one's own classes or vocabulary links gives one the flexibility to build conditions for rules.

### ActionCollection

This class, as previously discussed, is a collection of actions executed in sequence when the rule's condition evaluates to true. The class has two constructors. One takes no parameters and produces an empty collection. The other takes an instance of ICollection and creates an object based on an existing collection of actions. This class has a single property, Item, which functions as the class indexer in C#. It is a read/write property that takes an integer index and gets or sets an instance of the Function class. Function comes from the RuleEngine namespace. It is an abstract class that serves as the ancestor for any class implementing an action. This abstraction allows ActionCollection to handle all sorts of actions without special-purpose code. This class has eight methods, and several of them have overloaded forms. These methods are listed in Table 2.

TABLE 2
ActionCollection Class Methods

| Method | Forms | Meaning |
|---|---|---|
| Add | int Add(Function action) | Adds the Function or Object to the end of |
| | int Add(Systern.Object | collection. The Object form permits use with |
| | action) | existing components. The return value is the index |
| | | of the location where the item resides. |
| AddRange | void AddRange(ICollection | Adds the collection of actions to the end of the |
| | actions) | existing collection of actions. |
| Clone | object Clone( ) | Makes a deep copy of the object. |
| Contains | bool Contains(Function item) | Returns true if the item is found in the collection. |
| | bool Contains(System.Object | |
| | iPtem) | |
| CopyTo | void CopyTo(Function[] | Copies the entire collection to receiver beginning |
| | receiver, | at the location denoted by index. |
| | System.Int32 index) | |
| | void CopyTo(System.Array | |
| | receiver, | |
| | System.Int32 index) | |
| IndexOf | int IndexOf(Function item) | Returns the index of item in the actions collection, |
| | virtual int IndexOf(System. | or 1 if not found. |
| | Object item) | |
| Insert | void Insert(System.Int32 | Inserts action into the collection at the location |
| | index, Function action) | specified by index |
| | virtual void | |
| | Insert(System.Int32 | |
| | index, System.Object action) | |
| Remove | void Remove(Function | Removes action from the collection |
| | action) | |
| | virtual void Remove(System | |
| | Object action) | |

### FileRuleStore

The classes FileRuleStore and SqlRuleStore are derived from the inheritance tree with the RuleStore class at its head. The other classes formed an interrelated set of classes needed to make rules work as something one can execute. The storage classes are needed to give us a place to store vocabularies and rulesets. Most programmers will not be implementing their own rule store classes, so there is no great need to cover the abstract base class. When one is dealing with the SQL Server rule store, one can load rulesets using the methods of Policy and PolicyTester. For brevity's sake, one can look at the details of FileRuleStore as a means of orienting to the whole topic of rule storage. FileRuleStore has four constructors, covered in Table 3. Basically, all initialize the newly created object by locating the file store. The last three constructors add parameters for security and loading convenience.

TABLE 3
FileRuleStore Constructors

| Constructor | Usage |
|---|---|
| FileRuleStore(System.String) | Initializes the object using a URI locating the |
| | file-based rule store. |
| FileRuleStore(System.String uri, | Initializes the object using the store at uri in |
| IRuleLanguageConverter converter) | conjunction with convert. |
| | IRuleLanguageConverter is a class permitting |
| | loading and saving of rulesets and vocabularies |
| | to and from a stream object. |
| FileRuleStore(System.String uri, | Initializes the object at uri using credentials for |
| Systen.Security.Principal | authorization. |
| WindowsIdentity credentials) | |
| FileRuleStore(System.String uri, | Performs initialization of the store at uri, with |
| System.Security.Principal | security provided by credentials, and rules and |
| WindowsIdentity.credentials, | vocabularies in converter. |
| IRuleLanguageConverter converter) | |

FileRuleStore has no properties, but it does have six methods listed in Table 4. A file rule store is a simple collection of rulesets and vocabularies. These methods implement the common collection operations of adding, removing, and reading items in a collection.

TABLE 4
FileRuleStore Methods

| Method | Usage |
|---|---|
| override void Add(RuleSet rules, | Adds the ruleset(s), vocabulary(ies), or both to |
| System.Boolean publish) | the rule store. If publish is true, the items are |
| override void Add(RuleSetDictionary | published. |
| rulesets, System.Boolean publish) | |
| override void Add(Vocabulary names, | |
| System.Boolean publish) | |
| override void Add(VocabularyDictionary | |
| nameCollection, System.Boolean publish) | |
| override void Add(RuleSetDictionary | |
| rulesets, VocabularyDictionary | |
| nameCollection, System.Boolean publish) | |
| override RuleSet GetRuleSet(RuleSetInfo | Retrieves the ruleset described in rsInfo |
| rsInfo) | |
| override RuleSetInfoCollection | |
| [symbol] GetRuleSets(RuleStore.Filter filter) | |
| override RuleSetInfoCollection | Retrieves information about rulesets in the |
| .GetRuleSets(System.String name, | store that meet the criteria in filter and, if |
| [symbol] RuleStore.Filter filter) | included, name, where name is the name of |
| | the ruleset. RuleSet.Filter is an enumeration |
| | whose values are All, Published, Latest, and |
| | LatestPublished. |
| override VocabularyInfoCollection | Retrieves a list of objects describing the |
| GetVocabularies(RuleStore.Filter filter) | vocabularies that match filter and name. |
| override GetVocabularyInfoCollection | |
| GetVocabularies(System.String name, | |
| RuleStore.Filter filter) | |
| override Vocabulary GetVocabulary | Retrieves a vocabulary described in vInfo. |
| (VocabularyInfo vInfo) | |
| override void Remove(RuleSetInfo rsInfo) | |
| override void Remove(RuleSetInfoCollection | |
| rsInfos) | |
| override void Remove(VocabularyInfo vInfo) | |
| override void | Removes one or more rulesets or vocabularies |
| Remove(VocabularyInfoCollection vInfos) | described by the objects that describe them. |

One notes that GeTRuleSets and GetVocabularies do not retrieve rulesets and vocabularies directly. Rather, they represent queries on the rulestore to find all the rulesets or vocabularies that match certain criteria specified in the parameters of those methods. One may need to use GetruleSet or GetVocabulary to retrieve the actual ruleset or vocabulary one is interested in.

### IFactRetriever Interface

When writing a class that implements this interface, one may need to manage long-term fact-bases. The interface consists of a single method, so the complexity of this implementation is determined solely by the sophistication of the caching scheme. One may need to have a good estimate of how often the fact-base is likely to change and balance that information against the benefits to be gained from caching facts in memory. UpdateFacts is the method needed for implementation. This method returns an instance of System.Object, which is taken by the rule engine to be a handle to one's updated facts. The system will inspect the actual object you return in determining how to deal with it. For example, when it encounters an ADO database connection, it understands that it should use ADO objects and methods to retrieve facts from the database in question. UpdateFacts takes three parameters. The first parameter is a RuleSetInfo object describing the ruleset in use. The second is a reference to the RuleEngine object executing the ruleset. One uses the methods of these classes to get clues as to what facts are needed. The third parameter is a System.Object instance. The first time your class is called, this parameter will be null. Thereafter, this parameter is the return value of the previous invocation of UpdateFacts, thereby giving one even more information about the state of the fact-base.

### Configuration for Rules Conversion and Migration

### Static Methods can be Invoked in Rules

Static functions can be called directly in the rules. For example, one can directly call the DateTime.Now function or other similar standard functions inside rules without passing them as fact objects. To add the StaticSupport registry key:
Click Start; click Run, type RegEdit, and then click OK.
Expand HKEY_LOCAL_MACHINE, expand Software, expand Microsoft, expand BusinessRules, and then select 3.0.
In the right pane, right-click, point to New, and then click DWORD value.
For Name, type StaticSupport.

If the StaticSupport registry key already exists and one needs to change its value, one performs the following steps. To change the value of the StaticSupport registry key:
Click Start, click Run, type RegEdit, and then click OK.
Expand HKEY_LOCAL_MACHINE, expand Software, expand Microsoft, expand BusinessRules, and then expand 3.0.
Double-click the StaticSupport registry key, or right-click it and then click Modify.

The above key accepts one of three valid values as shown below:
0—This is the default value of the key and this value mimics the behavior of BizTalk Server 2004 where an instance of an object is always required as an input fact, and the method is only called when the rule is evaluated or executed.
1—An instance of the object is NOT required, and the static method is called whenever the rule is evaluated or executed
2—An instance of the object is NOT required, but the static method will be called at rule translation time (only if the parameters are constants). This value is primarily meant as a performance optimization. However, note that static members used as actions will NOT be executed at translation time, but static methods used as parameters may be executed.
   Thus, one needs to either use 1 or 2 to enable static support and invoke static methods directly.
   Overriding Registry Key with Application Configuration File

The registry entries can be overridden by using an application configuration file. The registry settings are global for all applications that host a rule engine instance. One can override these registry settings at an application level by using the application configuration file. For BizTalk Server applications, the host application is the BTSNTSvc.exe and the configuration file is the BTSNTSvc.exe.config, which one can find in the BizTalk Server installation directory. One may need to specify the values for the configuration parameters that one wants to override in the application configuration file as show below:

```
<configuration>
    <configSections>
        <section name=“Microsoft.RuleEngine”
  type=“System.Configuration.SingleTagSectionHandler” />
    </configSections>
    <Microsoft.RuleEngine
  UpdateServiceHost=“localhost”
  UpdateServicePort=“3132”
  UpdateServiceName=“RemoteUpdateService”
  CacheEntries=“32”
  CacheTimeout=“3600”
  PollingInterval=“60”
  TranslationTimeout=“3600”
  CachePruneInterval=“60”
  DatabaseServer=“(localhost)”
  DatabaseName=“BizTalkRuleEngineDb”
  SqlTimeout=“−1”
  StaticSupport=“1” />
</configuration>
```

### Programmatically Deploy Rules in BRE

Rules can be deployed programmatically using RuleSetDeploymentDriver class in the Microsoft.RuleEngine.RuleEngineExtensions namespace and invoking rules or policies inside the applications using the RuleEngineComponentConfiguration class. The following exemplifies coding to deploy rules programmatically:

string policyName = “TAS_E3000500”;
int majorRev = Convert.ToInt16(args[1]);
int minorRev = Convert.ToInt16(args[2]);
RuleSetInfo rsinfo = new RuleSetInfo(policyName,majorRev,minorRev);
Microsoft.BizTalk.RuleEngineExtensions.RuleSetDeploymentDriver dd;
depdriver = new Microsoft.BizTalk.RuleEngineExtensions.
RuleSetDeploymentDriver( );
depdriver.Deploy(rsinfo);

If one is deploying policies to the database that one's BizTalk Server environment is configured to use, one does not have to create the RuleSetDeploymentDriver object in the code. Instead, one can request the rule engine to create a RuleSetDeploymentDriver object for one by invoking the GetDeploymentDriver method of the Configuration class in the System.RuleEngine namespace. The following code sample demonstrates how to invoke the GetDeploymentDriver method:

Microsoft.BizTalk.RuleEngineExtensions.RuleSetDeploymentDriver dd;
dd = new Microsoft.RuleEngine.Configuration.GetDeploymentDriver( );

The GetDeploymentDriver method retrieves the values of the DeploymentDriverAssembly and DeploymentDriverClass registry keys under HKEY_LOCAL_MACHINE\Software\MicrosoftBusinessRules\3.0, and creates an instance of DeploymentDriverClass. The following are the two values for the above key:
DeploymentDriveAssembly—Microsoft.BizTalk.RuleEngineExtensions
DeploymentDriverClass—Microsoft.BizTalk.RuleEngineExtensions.RuleSetDeploymentDriver

The RuleSetDeploymentDriver class implements the IRuleSetDeploymentDriver interface. One can develop one's own policy deployment driver by creating a class that implements the IRuleSetDeploymentDriver interface and change the values for the registry keys described above as appropriate. The above RuleEngineComponentConfiguration method inside RuleEngineComponentConfiguration class can be used to pass custom facts as shown in the code below:

RuleSetExecutionConfiguration rec1 =
new RuleSetExecutionConfiguration( );
RuleEngineComponentConfiguration recc1=
new RuleEngineComponentConfiguration
(“FactRetrieverForE3000500”,
“Microsoft.Samples.BizTalk.TASPolicies.-
FactRetrieverForClaimsProcessing.DbFactRetriever”);
rec1.FactRetriever = recc1;
rs1.ExecutionConfiguration = rec1;

Apart from the above, a new method named Clear has been added to Policy class which resets the memory of the rule engine instance created for execution of the policy. Also support for Nullable types, generic methods and classes are other enhancements of Business Rules Engine in BizTalk Server 2006.

### Modifying Published Vocabularies and Rules

Like all software development, it usually requires many versions of a fact vocabulary before one can get it right. It would not be an overstatement to say one can easily end up with 20-30 versions of your vocabulary before one has one's rules working as desired. The alternative is to unpublish the vocabulary directly in the rules database. The process is:
1. Publish your vocabulary
2. Test your rules that refer to the vocabulary
3. Open the re_vocabulary table in the BizTalkRuleEngineDb and change the nStatus field from 1 to 0 (1=published, 0=not published). You can identify your vocabulary by its name held in the strName field.
4. Reload the vocabulary into the rules composer and add/modify your facts.
5. Save the vocabulary and then set the nStatus field back to 1—don't re-publish the vocabulary from the rules composer else you will get a primary key violation.
6. Reload the policies/vocabularies once more in the rules composer and retest your policy.

One can also use the same approach with the policy. Although one doesn't typically need to publish the rules to test them using the test facilities of the rules composer, one does if one intends to test them from one's orchestration. One can find bugs in this process just as much as during one's unit tests. Rather than creating a new version of the policies, one can change the nStatus field in the re_ruleset table to temporarily unpublish the policy so that one can edit it.

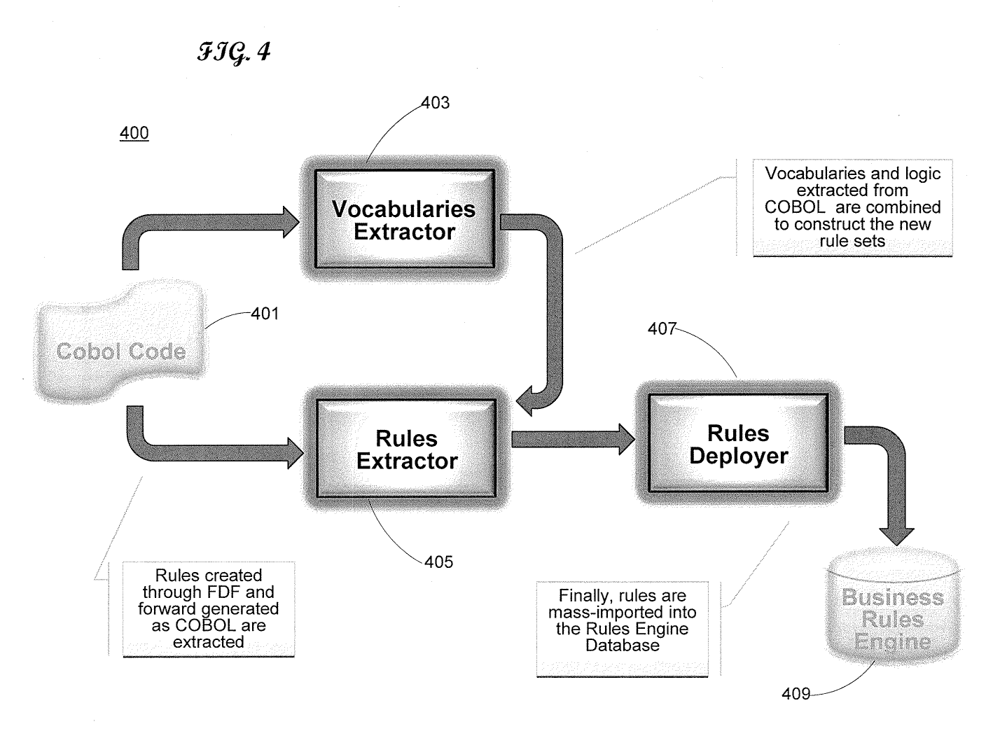

FIG. 4 shows an architecture 400 for converting a rules component in accordance with an embodiment of the invention. Rules are extracted by rules extractor 405 from COBOL code 401 (similar to the functionality provided by rules extractor 107 as shown in FIG. 1). Vocabularies (as extracted by vocabularies extractor 403) from COBOL code 401 and extracted logic are combined to form new rule sets, which are imported to business rules engine 409 by rules deployer 407.

### High Level Flows for Conversion of Rules Components

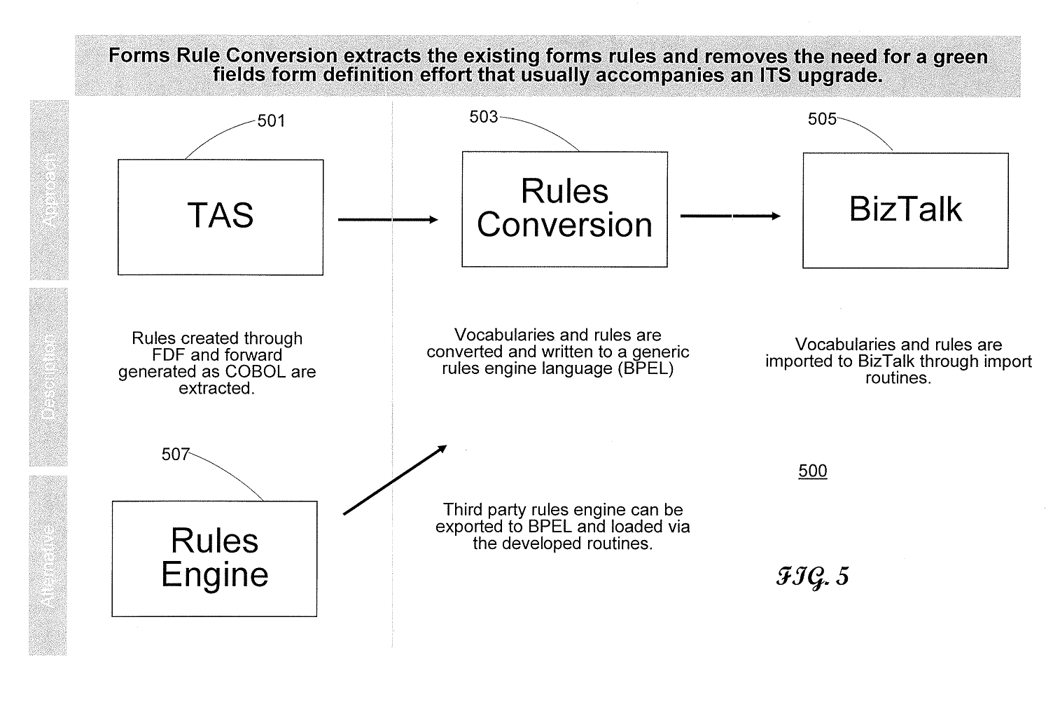

FIG. 5 shows high level flow 500 for performing form rules conversion in accordance with an embodiment of the invention. Vocabularies and rules are converted and written to a generic rules engine language (BPEL) from Accenture tax administration system (TAS) 501 by rules conversion module 503. Vocabularies and rules are imported to BizTalk 505 (corresponding to the business rules engine of target application 217 as shown in FIG. 2). Also, third party rules engine 507 may be exported to the BPEL and loaded via developed routines.

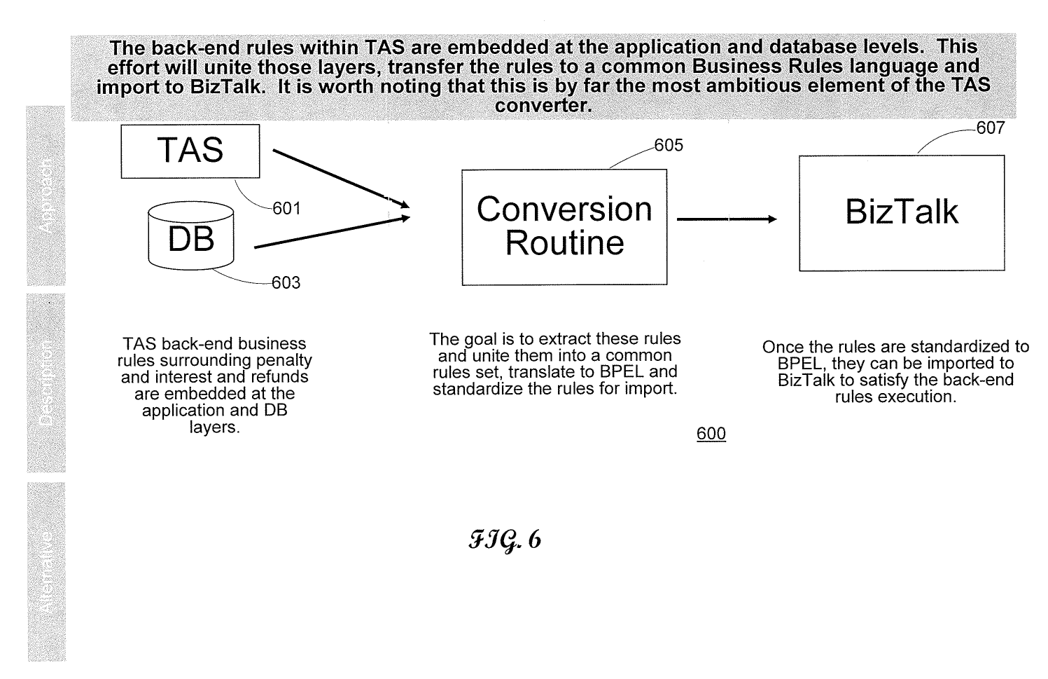

FIG. 6 shows high level flow 600 for performing back-end rules conversion in accordance with an embodiment of the invention. Conversion routine 605 extracts backend rules from TAS 601 and associated database 603. The rules are standardized to BPEL and are exported to BizTalk 607 for backend rules execution.

### Data Conversion

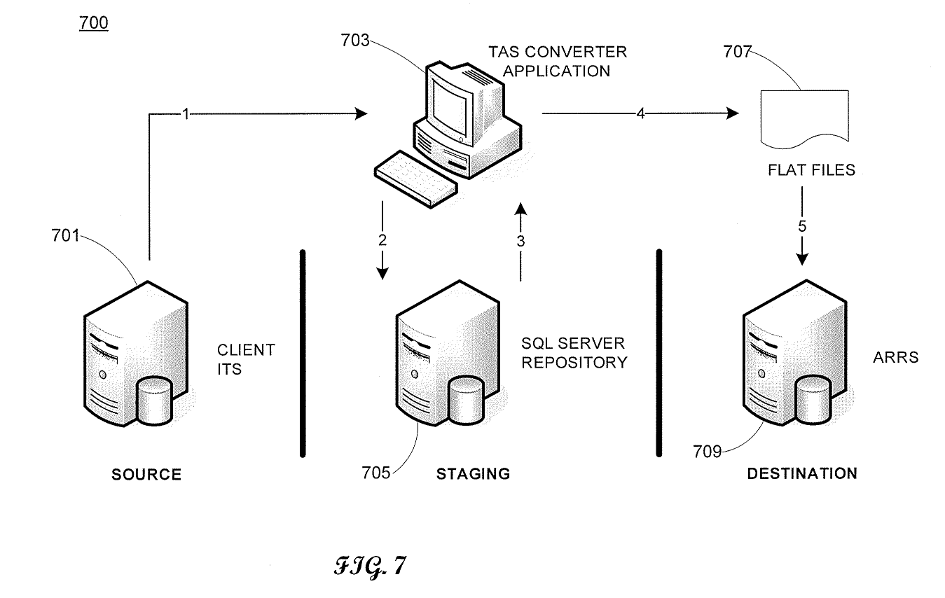

FIG. 7 shows data migration process 700 in accordance with an embodiment of the invention. The Accenture Enterprise Revenue Solution (AERS) program, in the pursuit of achieving greater client appeal, incorporates TAS conversion application 703, which converts rules and data from source server 701 and migrates the converted rules and data to destination server(s) 709 through staging server 705. The migration application provides TAS customers a fast-track approach to data conversion/switch over to AERS. The intent of the TAS Converter is to provide the following:
Provide an upgrade path for existing TAS clients
Reduce the cost of an ITS upgrade
Reduce the risk of an ITS upgrade
Reduce the time of a core upgrade

TAS Converter 703 incorporates the following areas for conversion: data conversion, form rules conversion, interface conversion, correspondence conversion, backend rules conversion, migration of revenue accounting chart of accounts, and conversion of existing TAS reports.

### Data Migration Process

At a high level, data migration goes through five steps, as described below.
1. TAS Converter application 703 selects and extracts data from the designated ITS (Integrated Tax System—which in this case is the Accenture Tax Administration System) backend structure 701. The application utilizes a combination of generic SQL “SELECT” and “JOIN” statements to pull relevant data.
2. The application performs any preliminary cleansing and formatting operations on extracted data. After, the ITS data is inserted and temporarily stored into the SQL Server repository 705.
3. The TAS Converter application 703 extracts all data from SQL repository 705, using generic SQL “Select” statements, for final data cleansing and formatting prior to flat file export.
4. All extracted data, via the TAS Converter application 703, undergoes required cleansing and formatting. After, the data is exported into auto-generated flat files 707 for bulk insert into the target system (SAP or another system) 709. The flat files are saved in a pre-designated file system location.
5. Emigall is used as a bulk insert program that uploads the data in the generated flat files into the SAP backend system 709.

TAS Converter 703 relies on a four tier structure that provides a generic, isolated and flexible method for migrating and cleansing ITS data into SAP system 709. This structure includes the following tiers:
Source—The “source” tier houses the customer's ITS, which maintains the original set of data to be migrated.
Staging—The “staging” tier provides a temporary structure, which receives “source” data to be cleansed and temporarily stored.
Destination—The “destination” tier receives and maintains the generated flat files that contain cleansed “staging”.
SAP—The “SAP” tier is the final destination of the source data.

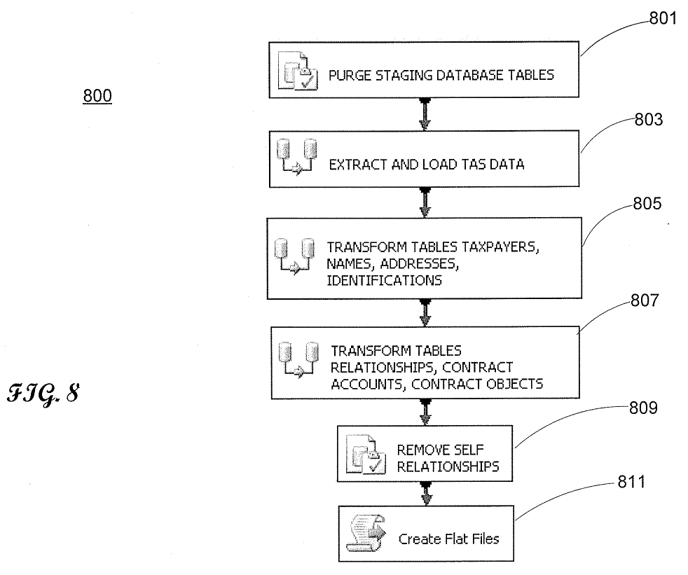

FIG. 8 shows TAS converter process 800 in accordance with an embodiment of the invention. Much of the migration process is managed by TAS converter process 800. Process 800, utilizing SSIS, performs the extraction, transformation, and loading of ITS data. Additionally, process 800 may provide a graphical interface which renders a visual progression of the migration flow.

The following steps are performed by TAS converter process 800.

Step 1: Purge Staging Database Tables (step 801)
Clear all Data out of the staging databases
   Step 2: Extract and Load TAS Data (step 803)
Extract Data from DB2 tables TF1ENTITY and TF1BUSDET Load into SQL table TAXPAYERS
Extract Data from DB2 tables TF1ADDR Load into SQL table ADDRESSES
Extract Data from DB2 tables TF1ID Load into SQL table IDENTIFICATIONS
Extract Data from DB2 tables TF1ACCT Load into SQL table ACCOUNTS
Extract Data from DB2 tables TF1RELA Load into SQL table RELATIONSHIPS
Extract Data from DB2 tables TF1NAME Load into SQL table NAMES
   Step 3: Transform Tables Taxpayers, Names, Addresses, Identifications (step 805)
Perform Transformations and Code Mappings for TAXPAYERS Load into TAXPAYERS_NEW
Perform Transformations and Code Mappings for ADDRESSES Load into ADDRESSES_NEW
Perform Transfomations NAMES Load into NAMES_NEW
Perform Transfomations and Code Mappings for IDENTIFICATIONS Load into IDENTIFICATIONS_NEW
Perform Transformations and Code Mappings for TAXPAYERS Load into TAXPAYERS_NEW
   Step 4: Transform Tables Relationships, Contract Accounts, Contract Objects (step 807)
Perform Transformations and Code Mappings for ACCOUNTS Load into ACCOUNTS_CA
Perform Transformations and Code Mappings for ACCOUNTS Load into ACCOUNTS_CO
Perform Transformations and Code Mappings for RELATIONSHIPS Load into RELATIONSHIPS_NEW
   Step 5: Remove Self Relationships (step 809)
Use SQL to remove all relationships with self
   Step 6: Create Flat Files (step 811)
Script generates the flat files TaxPayers.txt, ContractAccounts.txt, ContractObjects.txt, and Relationships.txt
It uses TASConverter.DataConversion class to preform the flat file creation
   Steps 7-8 (within SAP GUI—not explicitly shown in FIG. 8)

### Step 7: Create Import Files for SAP

Navigate to Transaction EMIGALL→Migration Object→Data Import
Create Import Files that SAP can load
Edit→Data→Upload

### Step 8: Run Data Import

Choose Import Data from Data menu

### High Level Flows for Conversion of Data Components

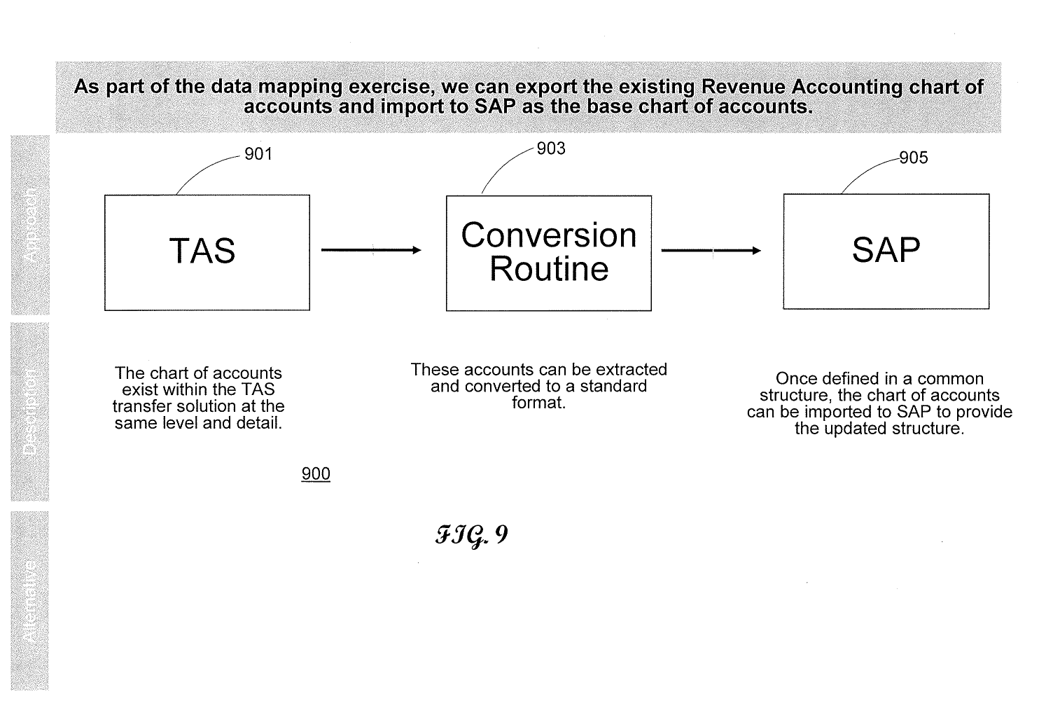

FIG. 9 shows high level flow 900 for converting a revenue accounting chart from a TAS in accordance with an embodiment of the invention. Conversion routine 903 obtains a chart of accounts from Accenture tax administration system (TAS) 901 and converts the chart of accounts to a standard format. Once in a common structure, the chart of accounts is imported to SAP server 905 to provide an updated structure.

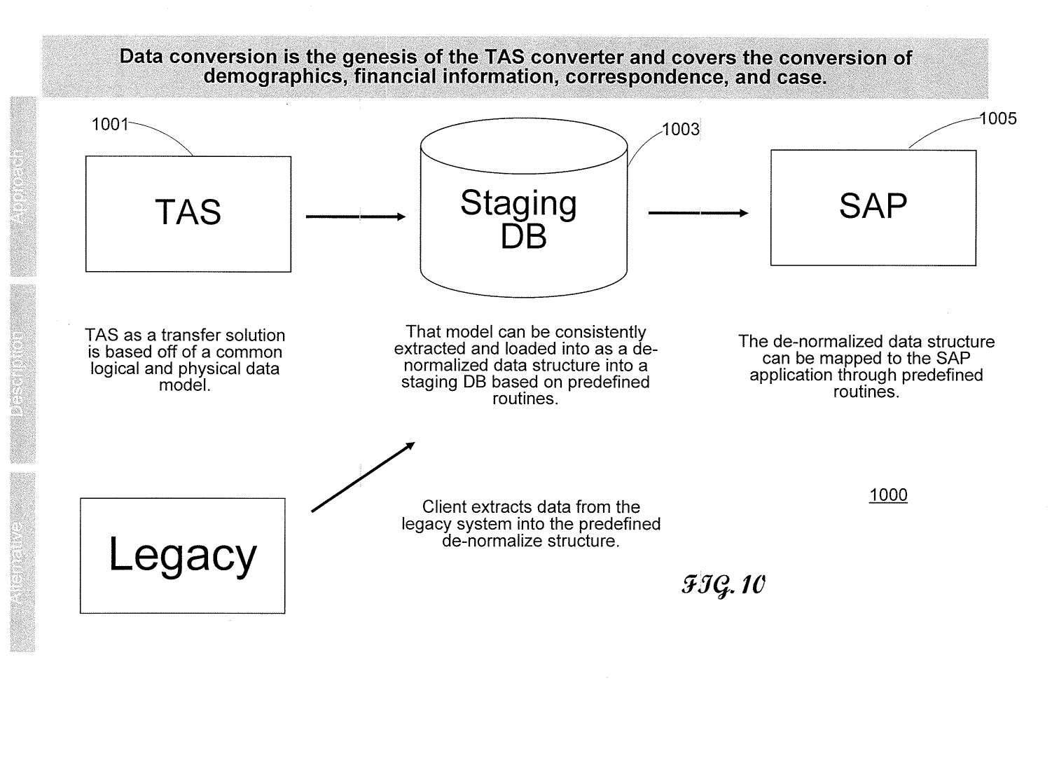

FIG. 10 shows high level flow 1000 for converting a data component from Accenture tax administration system (TAS) 1001 in accordance with an embodiment of the invention. Data elements of a data component are obtained from tax administration system 1001, in which legacy data elements are extracted into a predefined de-normalized structure. A de-normalized data structure for the data elements is mapped into SAP application 1005.

### High Level Flows for Conversion of Other Components

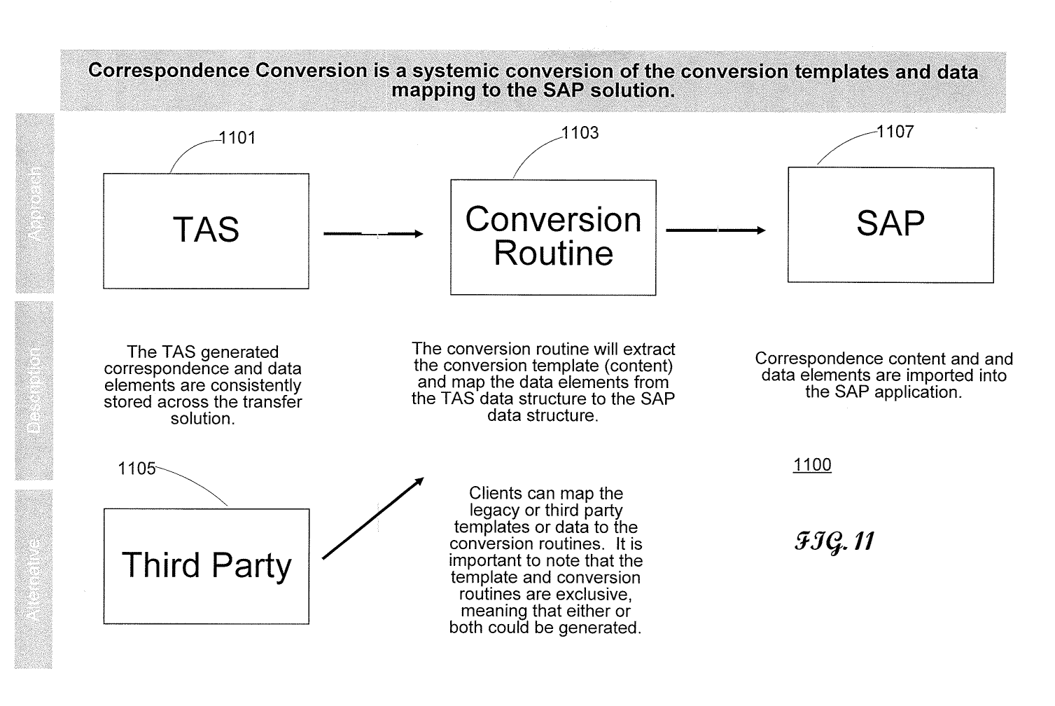

FIG. 11 shows high level flow 1100 of a correspondence component from tax administration system 1101 in accordance with an embodiment of the invention. Conversion routine 1103 maps correspondence data elements from Accenture tax administration system (TAS) 1101 to SAP data elements. The correspondence content and data elements are imported into SAP application 1107. Moreover, third party templates or data 1105 can be mapped to conversion routines.

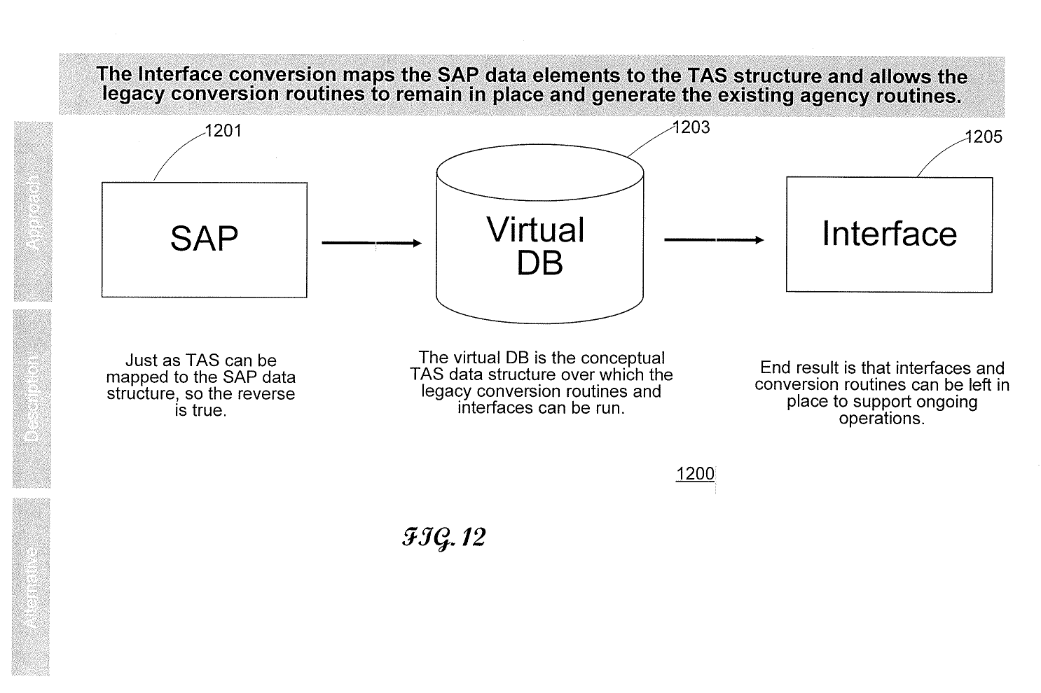

FIG. 12 shows high level flow 1200 for converting an interface component from tax administration system in accordance with an embodiment of the invention. Interface 1205 can be left in place to support ongoing operations by SAP server 1201. Virtual database 1203 is a conceptual TAS data structure over which legacy conversion routines and interfaces can be run.

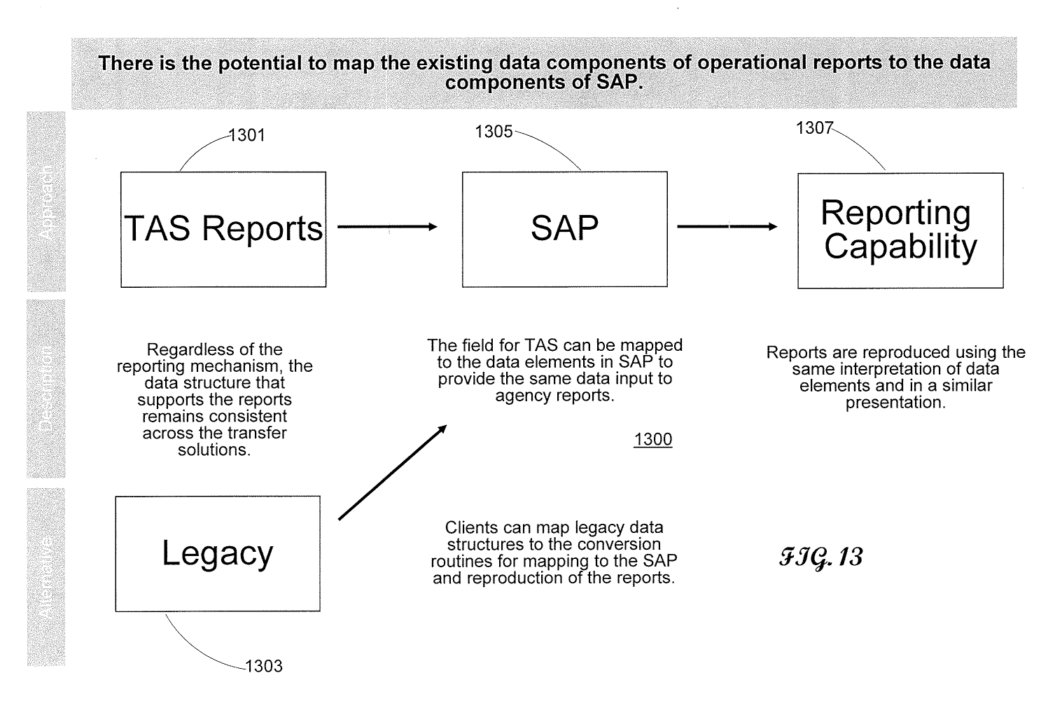

FIG. 13 shows high level flow 1300 for converting a reporting component from tax administration system 1301 in accordance with an embodiment of the invention. Data elements of a TAS report are mapped to data elements in the SAP system 1305 to provide the same data input to agency reports. Reporting capability 1307 enables reports to be reproduced using the same interpretation of data elements and in a similar presentation. Moreover, a client may map legacy data structures 1303 to the conversion routines for mapping to SAP system 1305.

### Exemplary TAS Demographic Table Descriptions

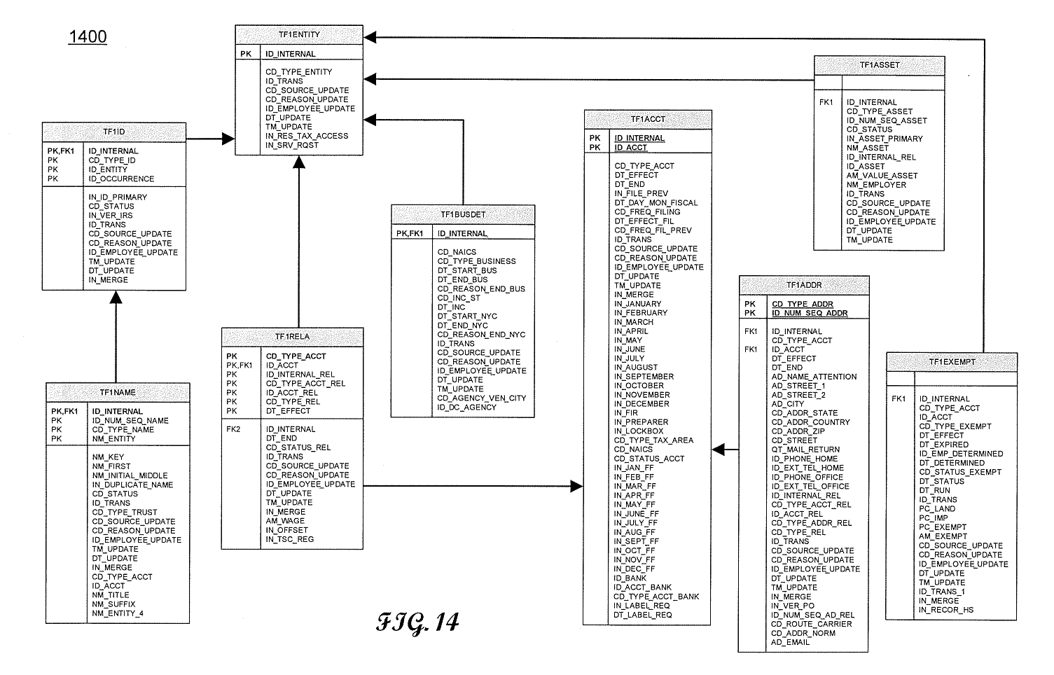

FIG. 14 shows TAS demographic table structures 1400 in accordance with an embodiment of the invention. The TAS Converter is developed and tested based on selected industry ITS and AERS-configured software used as source and destination backend systems. As a source ITS system, the Accenture TAS system was used, specifically with a backend configuration similar to an existing client implementation. The destination AERS backend system was the SAP PSCD module. With the involvement of Accenture management and SMEs, demographic data structures were selected the first series of data to be migrated. The TAS system contains nine backend tables which maintain demographic data and are processed with the TAS Converter. TAS demographic tables are detailed below.

TAS Demographic Data Structures

| | Entity Groups | ICP Table | Owner | LDM |
|---|---|---|---|---|
| 1 | Address | TF1ADDR | Client Registration | PP. 169-178 |
| 2 | Client | TF1ENTITY | Client Registration | PP. 268-270 |
| 3 | Client Account | TF1ACCT | Client Registration | PP. 067-070 |
| | | TF1BUSDET | Client Registration | PP. 074-079 |
| 4 | Client Details | TF1BUSDET | Client Registration | PP. 074-079 |
| 5 | Client Link | TE1RELA | Client Registration | PP. 015-021 |
| 6 | Client Role | TF1ACCT | Client Account | PP. 114-118 |
| | | TF1EXEMPT | | |
| 7 | External ID | TF1ID | Client Registration | PP. 001-006 |
| 8 | Name | TF1NAME | Client Registration | PP. 083-090 |
| 9 | Client Assets | TF1ASSETS | | |

### TAS Demographic Table Descriptions

### TF1ACCT:

The taxpayer may have records on this table for every tax type for which they are registered, e.g. Individual, Sales & Use, Corporate Income, Withholding, etc. For each, the table holds information such as the acct id (if applicable, only S&U and Withholding accounts), the effective dates for the account, the filing frequency, etc. Note: for seasonal filers, information regarding which months they file is stored.

### TF1ADDR:

The taxpayer can have more than one entry on this table, they can have different address types, e.g. primary, mailing, location, etc., and these different address types can be associated to the entire taxpayer or to a specific account type, e.g. sales & use, withholding, etc.

TF1ASSET:

A taxpayer may or may not have information on this table. The table stores asset information that has been gathered on the taxpayer that could be used for collection purposes (i.e. bank accounts, employers, etc.).

### TF1BUSDET:

Despite the name of this table, all taxpayers including individuals will have an entry on this table; although some fields are only relevant for business entities e.g. NAICS code. The table holds information such as the type of business, NAICS code and when the business started and/or ended.

### TF1ENTITY:

This table stores the type of entity, e.g. taxpayer, related party, property, etc., whether or not they are a restricted taxpayer, e.g. only able to be viewed by users with certain security, and whether or not they have a service request in the CRM system.

### TF1EXEMPT:

A taxpayer may or may not have information on this table. The table stores the type of exemption for a particular account, e.g. non-profit agency may have a record on this table for their S&U account.

### TF1ID:

The ID_INTERNAL is the unique identifier for every taxpayer; a taxpayer can have more than one entry on this table as they can have more than one external ID type, but only one external ID can be the primary ID.

### TF1NAME:

The taxpayer can have more than one entry on this table, as they can have more than one name type (i.e. legal, trade, etc.).

### TF1RELA:

A taxpayer may or may not have information on this table. This table links entities in the system to each other and indicates whether or not the relationship is eligible for offsets.

### Exemplary Requirements

The purpose of this section is to provide an overview of the hardware, and software requirements necessary to support the TAS Converter development infrastructure for AERS. Note: The software listed corresponds to the development and testing scenario used. The sequence in which these software components will be deployed and introduced into the TAS Converter technical landscape is explicitly covered in section Detailed Deployment Plan.

The TAS Converter will use the following Operating Systems in the AERS environment:
1 Windows 2003 servers—1 CPU, 2 GB RAM (DB2 DB)
1 Windows 2003 servers—1 CPU, 2 GB RAM (SQL Server DB)
1 Windows 2003 servers—1 CPU, 4 GB RAM (ECC 6.0)

The following software is required in order to build the TAS Converter development environment:
Microsoft SQL Server 2005 Enterprise Edition
IBM DB2 Version 9.1
Microsoft Visual Studio 2005 Professional Edition
Microsoft OLE DB Provider for DB2
Microsoft Visual Source Safe 2005 (Optional)
SAP mySAP ERP 2005 (PSCD)

### Exemplary Deployment Plan

The purpose of this section is to detail the sequence of steps required to setup the TAS Converter environment. This should serve as a roadmap for the TAS Converter team as they assemble the TAS Converter infrastructure.

This section is a high level detail of the software installation and its components. Users may refer to this section as a road map for the order and overview of the TAS Converter deployment.

### 1. Install SAP PSCD

a. Task installed by Basis team

### 2. IBM DB2 Install

a. Install DB2 V9
b. Import TAS table structures
   i Execute SQL insert queries
c. Upload TAS data
   i Map flat file fields

### 3. Microsoft OLE Data Provider for DB2 Install

a. DB2 Provider Install on development machine
b. DB2 Provider Install on runtime machine

### 4. Microsoft SQL Server 2005 Install

a. SQL Server 2005 Install on development machine
b. SQL Server 2005 Install on runtime machine
c. Import SQL table structures
   5. TAS Converter application import
a. Copy existing SSIS application
b. Upload to SSIS application to Visual Source Safe
c. Configure application
   i Configure data source credentials and locations
   ii Configure file system credentials and locations

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A method comprising:
(a) obtaining a first component from a legacy application;
(b) generating an intermediate state element from a legacy element, the legacy element contained in the first component; and
(c) converting the intermediate state element to a target element, a target application configured to utilize the target element.

2. The method of claim 1, wherein the first component comprises a rule component and further comprising:
(d) obtaining the rule component from the legacy application, the legacy application containing legacy source code specified in a first software language;
(e) generating an intermediate state expression from a legacy rule, the legacy rule contained in the rule component; and
(f) converting the intermediate state expression to a target rule, a target application configured to execute the target rule, the target application containing target source code specified in a second software language.

3. The method of claim 2, further comprising:
(g) obtaining a data component from the legacy application; and
(h) generating an intermediate data element from a legacy data element, the legacy data element contained in the data component; and
(i) converting the intermediate data element to a target data element.

4. The method of claim 3, further comprising:
(j) accessing the target data element when executing the target rule.

5. The method of claim 2, wherein the first software language and the second software language are different software languages.

6. The method of claim 2, wherein the first software language and the second software language are a same software language.

7. The method of claim 1, further comprising:
(d) obtaining a correspondence component from the legacy application;
(e) generating an intermediate correspondence element from a legacy data element, the legacy correspondence element contained in the correspondence component; and
(f) converting the intermediate correspondence element to a target correspondence element that is utilized by the target application.

8. The method of claim 1, further comprising:
(d) obtaining an interface component from the legacy application;
(e) generating an intermediate interface element from a legacy interface element, the legacy interface element contained in the interface component; and
(f) converting the intermediate interface element to a target interface element that is utilized by the target application.

9. The method of claim 1, further comprising:
(d) obtaining a reports component from the legacy application;
(e) generating an intermediate reports element from a legacy reports element, the legacy reports element contained in the reports component; and
(f) converting the intermediate reports element to a target reports element that is utilized by the target application.

10. The method of claim 1, further comprising:
(d) synchronizing the first component with another component when migrating from the legacy application to the target application.

11. The method of claim 1, further comprising:
(d) when an error is detected when migrating the legacy element to the target element, invoking an error recovery procedure.

12. The method of claim 2, wherein the first software language is specified by COBOL specifications.

13. The method of claim 1, wherein the legacy application is directed to a tax administration system.

14. The method of claim 2, further comprising:
(g) extracting a vocabulary item from the rule component, the vocabulary item associated with the legacy rule;
(h) aggregating the intermediate state expression with the vocabulary item to form the target rule;
(i) deploying the target rule to the target application.

15. An apparatus comprising:
a memory; and
a processor accessing the memory to obtain computer-executable instructions and executing the computer-executable instructions for performing:
(a) obtaining a rule component from the legacy application, the legacy application containing legacy source code specified in a first software language;
(b) generating an intermediate state expression from a legacy rule, the legacy rule contained in the rule component; and
(c) converting the intermediate state expression to a target rule, a target application configured to execute the target rule.

16. The apparatus of claim 15, the processor further executing the computer-executable instructions for performing:
(d) obtaining a data component from the legacy application;
(e) generating an intermediate data element from a legacy data element, the legacy data element contained in the data component; and
(f) converting the intermediate data element to a target data element, the target application configured to utilize the target data element when executing the target rule.

17. The apparatus of claim 15, the processor further executing the computer-executable instructions for performing:
(d) extracting a vocabulary item from the rule component, the vocabulary item associated with the legacy rule;
(e) aggregating the intermediate state expression with the vocabulary item; and
(f) deploying the target rule to the target application.

18. A tangible computer-readable medium having computer-executable instructions to perform:
(a) obtaining a rule component from the legacy application, the legacy application containing legacy source code specified in a first software language;
(b) generating an intermediate state expression from a legacy rule, the legacy rule contained in the rule component; and
(c) converting the intermediate state expression to a target rule, a target application configured to execute the target rule.

19. The tangible computer-readable medium of claim 18, further configured to perform:
(d) obtaining a data component from the legacy application;
(e) generating an intermediate data element from a legacy data element, the legacy data element contained in the data component; and
(f) converting the intermediate data element to a target data element, the target application configured to utilize the target data element.

20. The tangible computer-readable medium of claim 18, further configured to perform:
(d) extracting a vocabulary item from the rule component, the vocabulary item associated with the legacy rule;
(e) aggregating the intermediate state expression with the vocabulary item; and
(f) deploying the target rule to the target application.

21. A converter comprising:
a rules extractor obtaining a legacy rule from a rules component of a legacy application and converting the legacy rule to an intermediate state expression;
a rules deployer converting the intermediate state expression to a target rule and deploying the target rule at a target application;
a data extractor obtaining a legacy data element from a data component of the legacy application and converting the legacy data element to an intermediate data element; and
a data deployer converting the intermediate data element to a target data element and deploying the target data element at the legacy application.

22. The converter of claim 21, further comprising:
a vocabulary extractor extracting a vocabulary item from the rule component, the vocabulary item associated with the legacy rule;
an aggregator aggregating the intermediate state expression with the vocabulary item to form the target rule.

23. The converter of claim 21, the intermediate state expression being contained in a XML file.
